(19) United States
(12) Patent Application Publication
(10) Pub. No.: US 2009/0153458 A1
(43) Pub. Date: Jun. 18, 2009

(54) DRIVING METHOD AND DEVICE OF ELECTRO-OPTIC ELEMENT, AND ELECTRONIC EQUIPMENT

(75) Inventors: Daisuke KOJIMA, Chino-City (JP); Akihiko ITO, Nagano-ken (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/388,796

(22) Filed: Feb. 19, 2009

Related U.S. Application Data
(62) Division of application No. 10/086,543, filed on Mar. 4, 2002.

(30) Foreign Application Priority Data
Mar. 9, 2001 (JP) 2001-067646
Sep. 26, 2001 (JP) 2001-294702
Dec. 11, 2001 (JP) 2001-377794
Jan. 23, 2002 (JP) 2002-014765

(51) Int. Cl. G09G 3/36

(52) U.S. Cl. 345/89

(57) ABSTRACT

With the conventional technique, pixels can display different levels of grayscale resulting from irregularity of a relation in terms of position among selected sub-fields, when the same level of grayscale is displayed. The invention provides a pixel driving method that can include a selecting step of sequentially selecting, according to grayscale data, a plurality of first sub-field periods continuous with respect to one another and a plurality of second sub-field periods continuous with respect to one another and following consecutively the plurality of first sub-field periods in a direction moving away from a boundary of the plurality of first sub-field periods and the plurality of second sub-field periods, which is given as the origin, and a driving step of switching ON pixels during the selected sub-field periods.

This is a Division of application Ser. No. 10/086,543 filed Mar. 4, 2002. The disclosure of the prior application is hereby incorporated by reference herein in its entirety.

### BACKGROUND OF THE INVENTION

1. Field of Invention

The present invention relates to pixel driving method and device for driving pixels, which are electro-optic elements, by a pulse width modulation, and to electronic equipment.

2. Description of Related Art

Currently, a pixel driving method for driving a plurality of pixels aligned in a matrix-wise manner by using a scanning signal for selecting the pixels and a data signal for defining the level of grayscale the pixels should display is well known. As the pixel driving method, sub-field driving that applies the data signal to all the pixels in each of a plurality of periods (hereinafter, referred to as sub-fields) provided within one frame has been proposed to improve an image quality of a display image.

According to the sub-field driving, either of two voltages, a voltage (for example, high pulse) that displays ON (for example, black) and a voltage (low pulse) that displays OFF (for example, white), can be applied to each pixel as the data signal in each sub-field. Pulse width modulation can be effected on each pixel by the data signal within one frame, thereby allowing the pixel to display, for example, one of 64 levels of grayscale. However, in the case of the driving with N sub-fields in conventional 2^{N}-level grayscale, sub-fields to which the ON voltage should be applied are selected without any regularity from the plurality of sub-fields included in the frame. Accordingly, a problem can exist that, for example, pixels display different levels of grayscale when they should display the same level of grayscale due to irregularity of the relation in terms of position among the selected sub-fields. Also, in the case of the driving with (2^{N}−1) sub-fields in the conventional 2^{N}-level grayscale, there are so many sub-fields that the number of times a voltage is written into the pixels during one frame period is increased, and so is the power consumption. Further, because it is necessary to increase the number of levels of grayscale, that is, to further shorten the length of each sub-field with an increasing number of levels of grayscale, the data signal has to be applied under time constraints, which poses a problem that it is difficult to control the application of the data signal with a high accuracy.

### SUMMARY OF THE INVENTION

In order to solve the above problems, the present invention has an object to provide pixel driving method and device as well as electronic equipment each capable of avoiding or preventing a difference in a level of grayscale from occurring resulting from the positions of the sub-fields selected irregularly.

A driving method of an electro-optic element according to the present invention is a driving method of an electro-optic element for allowing the electro-optic element to display a level of grayscale. The electro-optic element should display throughout a frame period by switching ON the electro-optic element during a period corresponding to grayscale data that defines said level of grayscale. The driving method can include a selecting step of sequentially selecting according to the grayscale data a plurality of first sub-field periods continuous with respect to one another and a plurality of second sub-field periods continuous with respect to one another used to securing the period corresponding to the grayscale data, and following consecutively said plurality of first sub-fields. Each of the plurality of second sub-field periods having a length substantially equal to a length of a sum of the plurality of the first sub-field periods and one of the first sub-field periods, in a direction from a first sub-field period and a second sub-field period positioned abut on a boundary of said plurality of first sub-field periods and said plurality of second sub-field periods toward a first sub-field period and a second sub-field period at a remotest position from said boundary. The method can also include a driving step of switching ON said electro-optic element during said sub-field periods selected.

Another driving method of an electro-optic element according to the present invention is a driving method of an electro-optic element for allowing said electro-optic element to display a level of grayscale said electro-optic element should display throughout a plurality of frame periods by switching ON the electro-optic element during a period corresponding to grayscale data that defines said level of grayscale. The method can include a selecting step of sequentially selecting, according to the grayscale data and in each of said frame periods, a plurality of first sub-field periods continuous with respect to one another and a plurality of second sub-field periods continuous with respect to one another used for specifying the period corresponding to the grayscale data and included in each frame period forming said plurality of frame periods. The plurality of second sub-field periods following consecutively the plurality of first sub-field periods, each of which having a length equal to or greater than a length of a sum of all first sub-field periods included in the plurality of frame periods, in a direction from a first sub-field period and a second sub-field period positioned abut on a boundary of said plurality of first sub-field periods and said plurality of second sub-field periods toward a first sub-field period and a second sub-field period at a remotest position from said boundary. The method can further include a driving step of, in each of said frame periods, switching ON said electro-optic element during the sub-field periods selected.

Further another driving method of an electro-optic element according to the present invention is a driving method of an electro-optic element for allowing the electro-optic element to display a level of grayscale with a frame period made as a unit. The method can include a selecting step of sequentially selecting, according to values represented by low-order bits of data defining said level of grayscale, two or more first sub-field periods. The sub-field periods being adjacent to each other on one side of either before or after in time with respect to a reference point existing within said frame period and for switching ON or OFF the electro-optic element, toward the one side from said reference point, and along with this, sequentially selecting, according to values represented by high-order bits except said low-order bits of said data, second sub-field periods with one period set equal to or longer than a sum of said plurality of first sub-field periods, which second sub-field periods are one or more second sub-field periods existing or adjacent to each other on the other side of either before or after in time with respect to said reference point and, along with this, for switching ON or OFF said electro-optic element, toward said other side from said reference point. The method further including a driving step of continuously switching ON (or OFF) the electro-optic element during the first and second sub-field periods selected.

A driving device of an electro-optic element according to the present invention is a driving device of an electro-optic element for allowing the electro-optic element to display a level of grayscale the electro-optic element should display throughout a frame period by switching ON the electro-optic element during a period corresponding to grayscale data that defines the level of grayscale. The device can include a selecting circuit for sequentially selecting, according to the grayscale data, a plurality of first sub-field periods continuous with respect to one another and a plurality of second sub-field periods continuous with respect to one another used for specifying the period corresponding to the grayscale data. The plurality of second sub-field periods following consecutively the plurality of first sub-field periods, each of which substantially corresponding to a length of a sum of the plurality of first sub-field periods and any one of first sub-field periods, in a direction from a first sub-field period and a second sub-field period positioned abut on a boundary of said plurality of first sub-field periods and said plurality of second sub-field periods toward a first sub-field period and a second sub-field period at a position most remote from said boundary. The device can further include a driving circuit for switching ON said electro-optic element during said sub-field periods selected.

Another driving device of an electro-optic element according to the present invention is a driving device of an electro-optic element for allowing the electro-optic element to display a level of grayscale the electro-optic element should display throughout a plurality of frame periods by switching ON the electro-optic element during a period corresponding to grayscale data that defines said level of grayscale. The driving device can include a selecting circuit for sequentially selecting, according to said grayscale data and in each of said frame periods, a plurality of first sub-field periods continuous with respect to one another and a plurality of second sub-field periods continuous with respect to one another used for specifying the period corresponding to the grayscale data and included in each of the frame periods. The plurality of second sub-field periods following consecutively the plurality of first sub-field periods, each of which having a length equal to or more than a length of a sum of all first sub-field periods included in the plurality of frame periods, in a direction from a first sub-field period and a second sub-field period positioned abut on a boundary of the plurality of first sub-field periods and the plurality of second sub-field periods toward a first sub-field period and a second sub-field period at a position most remote from the boundary. The driving device can include a driving circuit for, in each of the frame periods, switching ON the electro-optic element during the sub-field periods selected.

Further another driving device of an electro-optic element according to the present invention is a driving device of an electro-optic element for allowing the electro-optic element to display a level of grayscale with a frame period made as a unit. The driving device further including a selecting circuit for sequentially selecting, according to values represented by low-order bits of data defining said level of grayscale, two or more first sub-field periods, which are adjacent to each other on one side of either before or after in time with respect to a reference point existing within said frame period and for switching ON or OFF the electro-optic element, toward the one side from said reference point, and along with this, sequentially selecting, according to values represented by high-order bits except said low-order bits of said data, second sub-field periods with one period set equal to or longer than a sum of said plurality of first sub-field periods, which second sub-field periods are one or more second sub-field periods existing or adjacent to each other on the other side of either before or after in time with respect to the reference point and, along with this, for switching ON or OFF the electro-optic element, toward the other side from said reference point. The device can further include a driving circuit for continuously switching ON (or OFF) the electro-optic element during the first and second sub-field periods selected.

Electronic equipment according to the present invention is characterized by comprising: a display device, including a plurality of electro-optic elements aligned in a matrix-wise manner, for displaying an image related to said electronic equipment; and either of the above driving devices of an electro-optic element.

### BRIEF DESCRIPTION OF THE DRAWINGS

The invention will be described with reference to the accompanying drawings, wherein like numerals reference like elements, and wherein:

FIG. 1 is a view showing an arrangement of an exemplary electro-optic device of a first embodiment;

FIG. 2 is a view showing an arrangement of an exemplary pixel provided in a display unit of the first embodiment;

FIG. 3 is a view showing a structure of the electro-optic device of the first embodiment;

FIG. 4 is a view showing an arrangement of an exemplary data line driving circuit of the first embodiment;

FIG. 5 is a view showing an arrangement of an exemplary start pulse generating circuit of the first embodiment;

FIG. 6 is a time chart showing an operation of the start pulse generating circuit of the first embodiment;

FIG. 7 is a view showing an arrangement of an exemplary data converting circuit of the first embodiment;

FIG. 8 is a view showing an exemplary truth table a decoder of the first embodiment uses;

FIG. 9 is a time chart showing waveforms of signals in the first embodiment;

FIG. 10 is a view showing sub-fields in the first embodiment;

FIG. 11 is a view showing sub-fields according to an application example of the first embodiment;

FIG. 12 is a view showing an arrangement of a start pulse generating circuit in the application example of the first embodiment;

FIG. 13(a) is a diagram showing level of grayscale to transmittance characteristic in the first embodiment, and FIG. 13(b) is a diagram showing level of grayscale to transmittance characteristic in the application example;

FIG. 14 is a view illustrating a case with the numbers of division being nonuniform in the application example;

FIG. 15 is a view illustrating a case with the sub-fields to be divided being made different in the application example;

FIG. 16 is a view showing an arrangement of an exemplary start pulse generating circuit of a second embodiment;

FIG. 17 is a view showing an arrangement of an exemplary data converting circuit of the second embodiment;

FIG. 18 is a time chart showing waveforms of signals in the second embodiment;

FIG. 19 is a view showing sub-fields in the second embodiment;

FIG. 20 is a view showing an arrangement of an exemplary start pulse generating circuit of a third embodiment;

FIG. 21 is a view showing an arrangement of an exemplary data converting circuit of the third embodiment;

FIG. 22 is a view showing an operation of an exemplary electro-optic device of the third embodiment;

FIG. 23 is a view showing sub-fields in the third embodiment;

FIG. 24 is a view showing sub-fields in a fourth embodiment;

FIG. 25 is a view showing sub-fields in a fifth embodiment;

FIG. 26 is a view illustrating a case with the numbers of division being nonuniform in the fifth embodiment;

FIG. 27 is a view showing an arrangement of a data converting circuit of a sixth embodiment;

FIG. 28 is a view showing a truth table a decoder of the sixth embodiment uses;

FIG. 29 is a time chart showing waveforms of signals in the sixth embodiment;

FIG. 30 is a view showing sub-fields in the sixth embodiment;

FIG. 31 is a view showing selection patterns in each frame in the sixth embodiment;

FIG. 32 is a view showing an arrangement of a data converting circuit of a sixth embodiment;

FIG. 33 is a view showing sub-fields in the sixth embodiment;

FIG. 34 is a view showing selection patterns in each frame in the sixth embodiment;

FIG. 35 is a view showing an arrangement of electronic equipment of an seventh embodiment; and

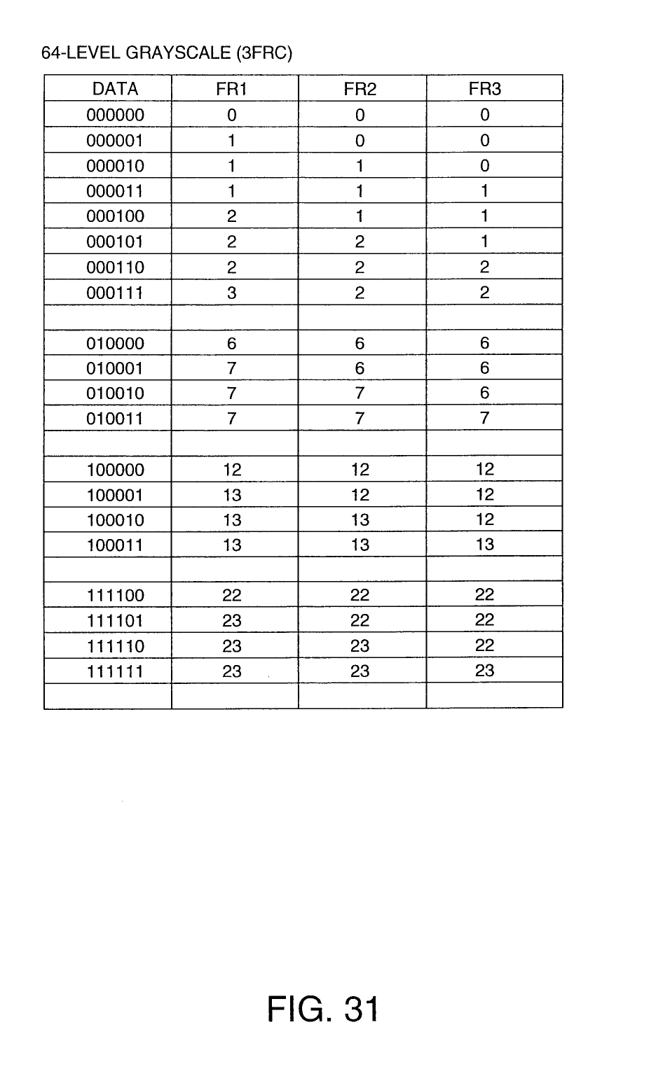

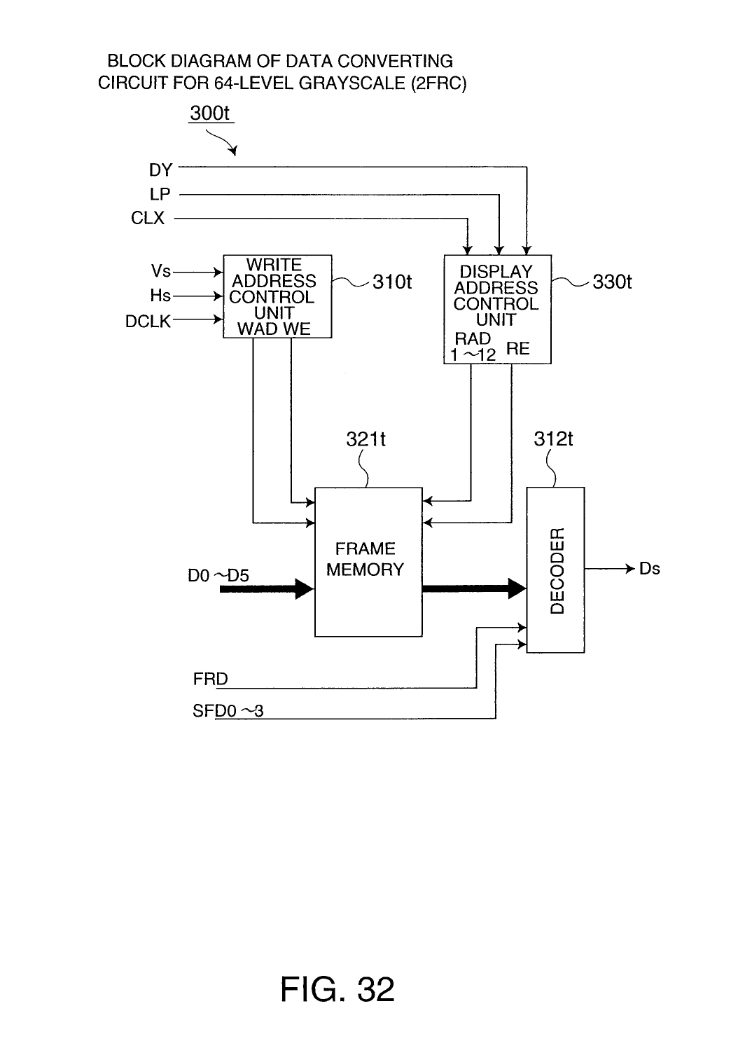

FIG. 31 is a view showing arrangements of a projector, a mobile-type computer, and a cellular phone.

### DETAILED DESCRIPTION OF PREFERRED EMBODIMENTS

The following description will describe embodiments of the present invention with reference to the drawings. In particular, the following description will describe an electro-optic device 1 using a sub-field driving method, which is the pixel driving method according to the present invention.

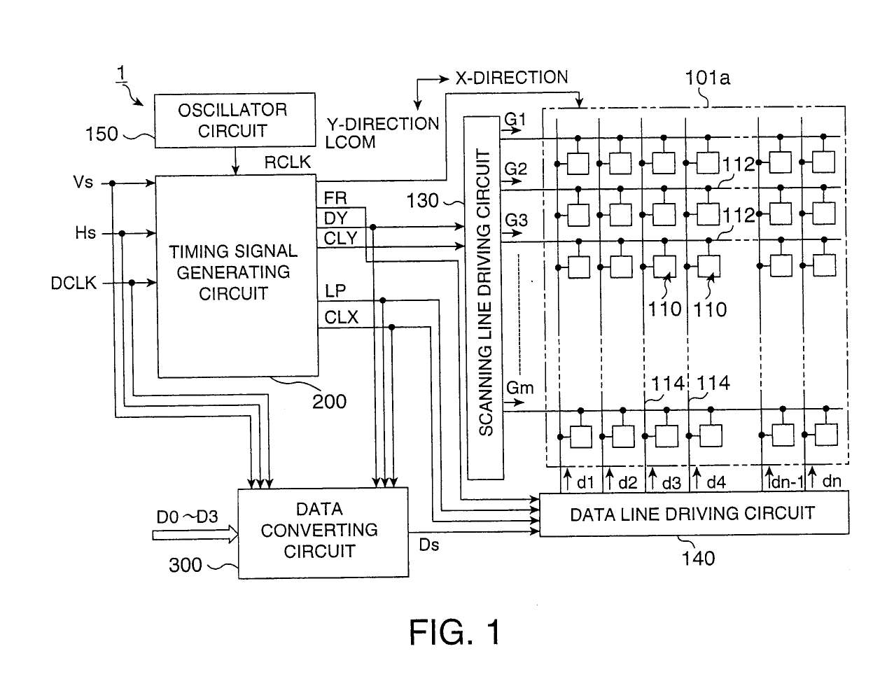

FIG. 1 shows an arrangement of an electro-optic device of a first embodiment. The electro-optic device is provided with a plurality of pixels aligned in a matrix between an element substrate and a counter substrate. A predetermined number of pixels aligned in the row direction (X) are selected concurrently and such a selection is performed sequentially in a vertical direction, in other words, line-sequentially. As the selection occurs, a signal defining a level of grayscale, that is, 0 or +V, is applied to the pixels within one frame, that is, during a period of one frame, thereby allowing each pixel to display that level of grayscale. To be more specific, the electro-optic device selects, for example, a predetermined number of pixels aligned in one row in each of a plurality of sub-fields that together form one frame. Pulse width modulation is effected to these pixels within one frame depending on in which sub-fields a voltage is applied to these pixels. Consequently, it is possible to allow these pixels to display a particular level of grayscale during one frame by changing a voltage root-mean-square value applied to the pixels.

Hereinafter, application of ±V is referred to as ON and application of 0 is referred to as OFF. It should be appreciated, however, that because liquid crystals demand alternating driving, application of +V and application of −V are substantially equivalent in terms of grayscale.

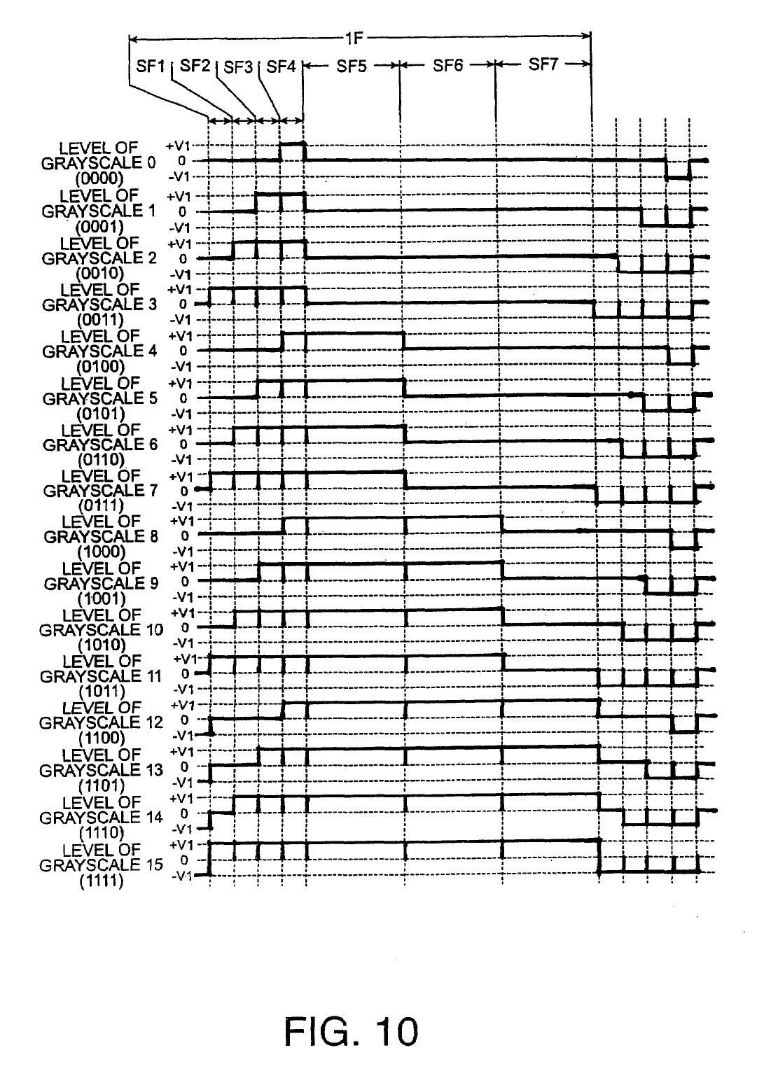

FIG. 10 shows sub-fields. As shown in FIG. 10, one frame (1F) can be composed of sub-fields SF1-SF7. A weight assigned to the length of the sub-fields SF1-SF3 is set small, whereas a weight assigned to the length of the sub-fields SF5-SF7 is set large. For example, assume that grayscale data, which is supplied to the electro-optic device and defines a level of grayscale the pixels should display, determines 16 levels with four bits. Then, the length of each of the sub-fields SF1-SF3 corresponds to the level 1, and the length of each of the sub-fields SF5-SF7 corresponds to the level 4. In other words, the length of the sub-fields SF5-SF7 is substantially equal to the sum of a total of the lengths of the three sub-fields SF1-SF3 and the length of one of these sub-fields. In order to give a threshold voltage Vth relating to the driving of liquid crystals, the sub-field SF4 provided between the sub-fields SF1-SF3 and the sub-fields SF5-SF7 is always kept switched ON regardless of a level of grayscale.

The ON/OFF state of (the pixel in) the sub-fields SF5-SF7 is determined by high-order two bits in the 4-bit grayscale data. In other words, the sub-fields SF5-SF7 are selected sequentially along a direction from the sub-field SF5 to the sub-field SF7 according to the high-order two bits. For example, given “00” as the high-order two bits, then all the sub-fields SF5-SF7 are switched OFF; given “01”, then the sub-field SF5 alone is switched ON; given “10”, then the sub-fields SF5 and SF6 are switched ON; and given “11”, then all the sub-fields SF5-SF7 are switched ON.

The ON/OFF state of the sub-fields SF1-SF3 is determined by low-order two bits in the 4-bit grayscale data. In other words, the sub-fields SF1-SF3 are selected sequentially along a direction from the sub-field SF3 to the sub-field SF1 according to the low-order two bits. For example, given “00” as the low-order two bits, then all the sub-fields SF1-SF3 are switched OFF; given “01”, then the sub-field SF3 alone is switched ON; given “10”, then the sub-fields SF2 and SF3 are switched ON; and given “11”, then all the sub-fields SF1-SF3 are switched ON.

The following description will describe more in detail the ON/OFF states of the sub-fields SF5-SF7 and the sub-fields SF1-SF3. For example, given “1001” that defines the level 9 as the grayscale data, then as shown in FIG. 10, the sub-fields SF5 and SF6 are switched ON and the sub-field SF3 is also switched ON. Also, for example, given “1110” that defines the level 14 as the grayscale data, then, as shown in FIG. 10, all the sub-fields SF5-SF7 are switched ON and the sub-fields SF2 and SF3 are also switched ON.

Here, assume that the N-bit grayscale data that defines 2^{N} power levels (N is an integer not less than 2) is divided into high-order M bits (M is a positive integer less than N) and low-order (N−M) bits. Then, the number of a plurality of first sub-fields corresponding to the low-order (N−M) bits and the number of a plurality of second sub-fields corresponding to the high-order M bits are (2^{N-m}−1) and (2^{M}−1), respectively. Further, let a be the weight assigned to the first sub-fields, then the weight assigned to the second sub-fields is α2^{N-M}.

As has been discussed above, from a plurality of sub-fields (SF5-SF7) continuous with respect to one another and a plurality of sub-fields (SF1-SF3) continuous with respect to one another, selections are made sequentially from the boundary (a reference point) between the sub-fields SF5 and SF3 substantially adjacent to each other, that is, in a direction from (the rear end of) the sub-field SF4 to the sub-field SF1 or to the sub-field SF7. In other words, the sub-fields SF1-SF3 and the sub-fields SF5-SF7 are selected sequentially from the center to the outside of the frame period. Hence, the sub-fields that should be switched ON can be selected continuously regardless of a value of the grayscale data, thereby making it possible to avoid the occurrence of a defect in a level of grayscale resulting from the discontinuity of the sub-fields.

Also, by providing the sub-field SF4 that should be always kept switched ON at the boundary between the sub-field of the high-order bit and the sub-field of the low-order bit, a voltage root-mean-square value corresponding to the characteristics of the liquid crystals can be applied to the liquid crystals while maintaining the above continuity, thereby making it possible to control a level of grayscale precisely.

Referring to FIG. 1 again, the electro-optic device can include, as shown in FIG. 1, a display unit 101a, an oscillator circuit 150, a timing signal generating circuit 200, a data converting circuit 300, a scanning line driving circuit 130, and a data line driving circuit 140.

The display unit 101a is provided with the plurality of pixels 110 aligned in m rows and n columns, on which scanning lines 112 for selecting the plurality of pixels 110 are formed so as to extend in an X (row) direction, while data lines 114 for supplying data signals defining the levels of grayscale of the plurality of pixels 110 are formed so as to extend in a Y (column) direction.

The timing signal generating circuit 200 generates signals LCOM, FR, DY, CLY, LP, and CLX shown in FIG. 1 based on a vertical synchronizing signal Vs, a horizontal synchronizing signal Hs, and a dot clock signal DCLK of input grayscale data D0-D3 supplied from a host device (not shown), and a basic clock RCLK of readout timing supplied from the oscillator circuit 150.

A driving signal LCOM is a constant potential (0 potential) applied to counter electrodes on the counter substrate to drive the plurality of pixels 110. An alternating signal FR specifies the timing at which the polarity of an applied voltage to the liquid crystals is reversed per frame. A start pulse DY specifies the position of each of the sub-fields SF1-SF7. A clock signal CLY is used to define a horizontal scanning period at the scanning side (Y side). A latch pulse LP defines a horizontal scanning period (1H). A clock signal CLX is a dot clock signal for a display use.

The data converging circuit 300 is supplied with grayscale data D0-D3 that defines 16 levels of grayscale with four bits. Herein, for example, D3 is the most significant bit, whereas D0 is the least significant bit. The data converting circuit 300 generates a data signal Ds based on the grayscale data D0-D3, and outputs the data signal Ds to the data line driving circuit 140.

The scanning line driving circuit 130 supplies m scanning lines 112 included in the display unit 101a with scanning signals G1, G2, G3, . . . , and Gm, respectively, on the basis of the signals DY and CLY outputted from the timing signal generating circuit 200, and selects each of the m scanning lines 112 a plurality of times during the horizontal scanning period 1H. More specifically, in the case that one frame is composed of seven sub-fields shown in FIG. 10, the scanning line driving circuit 130 selects each scanning line 112 seven times within one frame. The data line driving circuit 140 supplies the pixels 110 of one row for the selected scanning line 112 with data signals d1, d2, d3, . . . , and dn through n data lines 114, respectively, on the basis of the signals FR, LP and CLX outputted from the timing signal generating circuit 200 and the data signal Ds outputted from the data converting circuit 300.

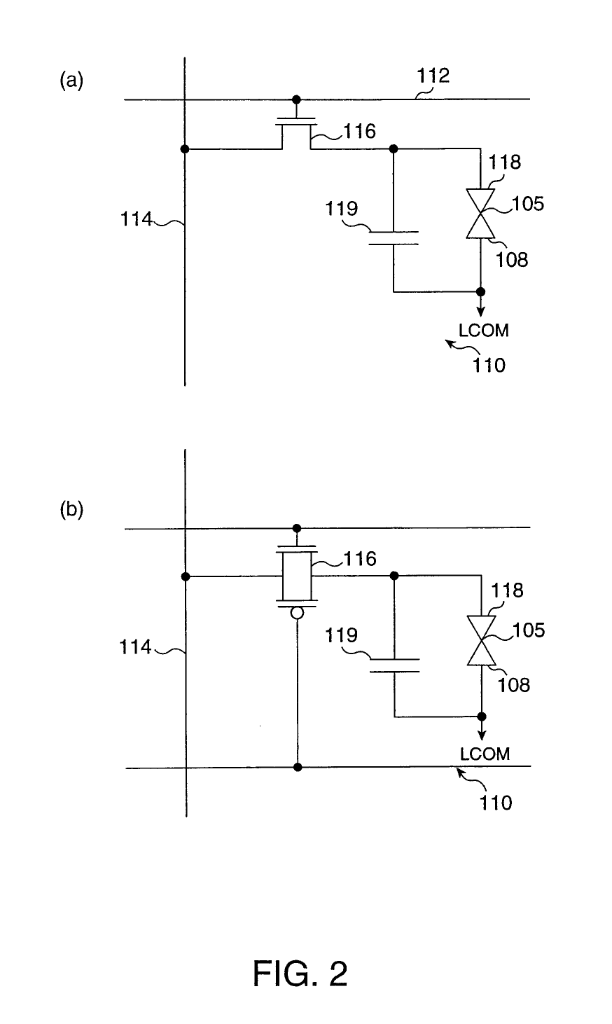

FIG. 2(a) shows an arrangement of the pixel provided in the display unit. As shown in the drawing, the gate, source and drain of a thin film transistor (TFT) 116 are connected to the scanning line 112, the data line 114, and a pixel electrode 118, respectively, and liquid crystals 105, which are electro-optic materials, are sandwiched in a space between the pixel electrode 118 and a counter electrode 108. An accumulation capacitance 119 for retaining charges is formed between the pixel electrode 118 and the counter electrode 108.

In order to reduce an offset voltage between an applied voltage to the pixel electrode 118 and an applied voltage to the data line 114, a pixel is preferably arranged so as to complementarily combine a P-channel type transistor and an N-channel type transistor as shown in FIG. 2(b) by using the pixel arranged as shown in FIG. 2(a). In case that the transistor of one type is used as shown in FIG. 2(a), the offset voltage is necessary.

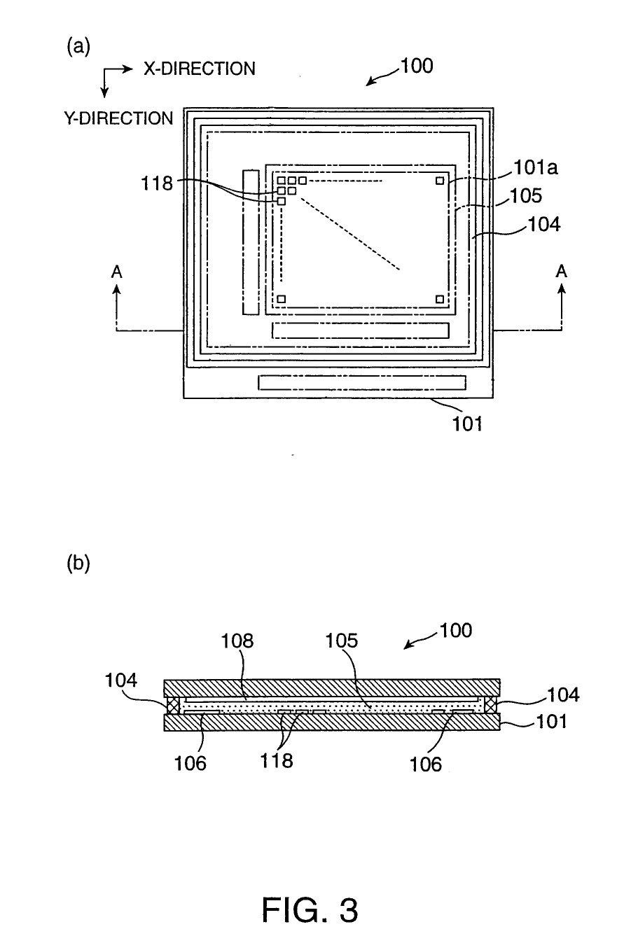

FIGS. 3(a) and 3(b) show a structure of the electro-optic device. The electro-optic device 100 can include, in addition to the components shown in FIG. 1, for example, a sealing member 104, a light blocking film 106, a polarization plate, an alignment film, and a color filter.

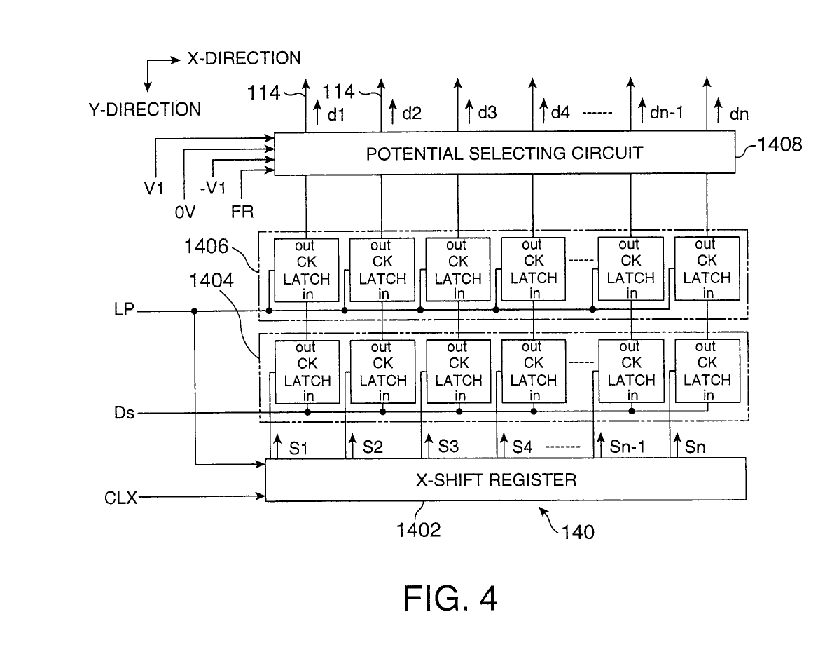

FIG. 4 shows an arrangement of the data line driving circuit. The data line driving circuit 140 shown in FIG. 1 can include, as shown in FIG. 4, an X-shift register 1402, a first latch circuit 1404, a second latch circuit 1406, and a potential selecting circuit 1408.

The X-shift register 1402 sequentially supplies the first latch circuit 1404 with the latch pulse LP supplied from the timing signal generating circuit 200 in the form of latch signals S1, S2, S3 . . . , and Sn according to the clock signal CLX supplied also from the timing signal generating circuit 200.

The first latch circuit 1404 sequentially latches the data signal Ds outputted from the data converting circuit 300 at the fall of the latch signals S1, S2, S3, . . . , and Sn. The second latch circuit 1406 collectively latches the data signals Ds, which have been latched by the first latch circuit 1404, at the fall of the latch pulse LP and transfers the same to the potential selecting circuit 1408.

The potential selecting circuit 1408 converts the latched data signals Ds into the data signals d1, d2, d3, . . . , and dn in response to alternating signal FR outputted from the timing signal generating circuit 200, and applies the same to the data lines 114. To be more specific, when the alternating signal FR is at the L level, the potential selecting circuit 1408 converts the H level of the data signals d1, d2, d3, . . . , and dn to +V1, and on the other hand, when the alternating signal FR is at the H level, it converts the H level of the data signals d1, d2, d3, . . . , and dn to −V1. The potential selecting circuit 1408 converts the L level of the data signals d1, d2, d3 . . . , and dn to the 0 potential regardless of whether the alternating signal FR is at L or H.

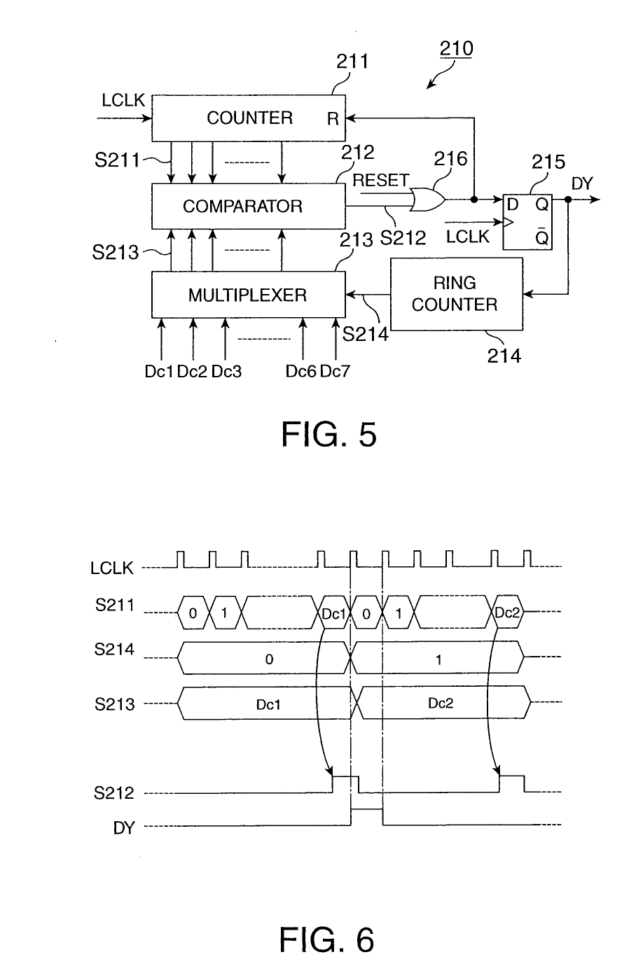

FIG. 5 shows an arrangement of a start pulse generating circuit, and FIG. 6 is a time chart showing an operation of the start pulse generating circuit. The start pulse generating circuit 210 is provided to the timing signal generating circuit 200 shown in FIG. 1 and generates the start pulse DY.

The start pulse generating circuit 210 can include, as shown in FIG. 5, a counter 211, a comparator 212, a multiplexer 213, a ring counter 214, a D flip-flop 215, and an OR circuit 216.

The counter 211 counts a line clock signal LCLK that is in sync with the clock signal CLY, and a count value is reset by an output signal from the OR circuit 216.

The ring counter 214 counts the number of start pulses DY, and the multiplexer 213 selectively outputs count data Dc1, Dc2, . . . , and Dc7 respectively specifying the periods of time of the sub-fields SF1-SF7 based on a count result S214 of the ring counter 214.

The comparator 212 compares a count value S211 of the counter 211 with an output data value S213 of the multiplexer 213, and outputs a coincidence signal S212 at the H level when the two values coincide. The comparator 212 outputs the coincidence signal S212 when the count value S211 of the counter 211 reaches the break of the sub-field. Because the coincidence signal is fed back to a reset terminal of the counter 211 through the OR circuit 216, the counter 211 starts to count again from the break of the sub-field.

The D flip-flop 215 latches an output signal from the OR circuit 216 according to the line clock signal LCLK, and generates the start pulse DY.

One input end of the OR circuit 216 is supplied with a reset signal RESET that stays at the H level only for one cycle of the line clock signal LCLK. Consequently, the count value of the counter 211 is reset at the start point of the frame.

When the coincidence signal S212 rises, the start pulse DY initially rises at the rising timing of the line clock signal LCLK. On the other hand, the count value S211 and the output data value S213 have a discrepancy as the line clock signal LCLK rises, whereupon the coincidence signal S212 shifts to the L level. Hence, when the line clock signal LCLK rises next, the coincidence signal S212 at the L level is latched by the D flip-flop 215, whereby the start pulse DY shifts to the L level. In this manner, the start pulse DY is outputted first in each sub-field.

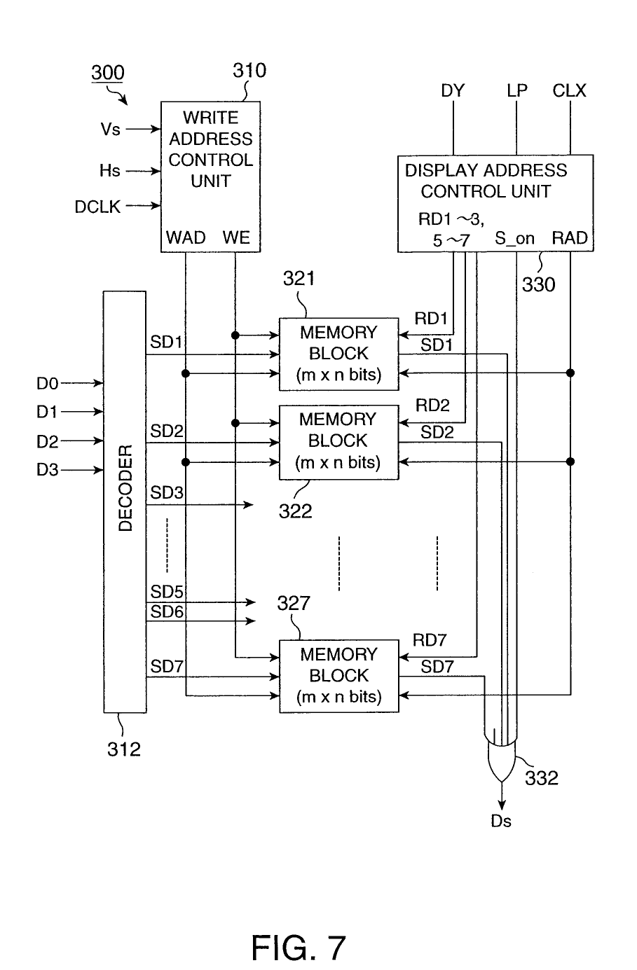

FIG. 7 shows an arrangement of the data converting circuit. The data converting circuit 300 shown in FIG. 1 can include a write address control unit 310, a decoder 312, a plurality of memory blocks 321-327, a display address control unit 330, and an OR circuit 332.

Upon input of the grayscale data D0-D3, the decoder 312 converts the grayscale data D0-D3 into sub-field data SD1-SD3 and SD5-SD7, which is bit data corresponding to the ON/OFF state of each of the sub-fields SF1-SF3 and SF5-SF7. The memory blocks 321-327 are provided to store the sub-field data SD1-SD3 and SD5-SD7, respectively, and each has a memory space of m×n bits in response to a display area (m rows×n columns) on the element substrate 101. The memory blocks 321-327 perform the writing and reading operations asynchronously and independently.

The write address control unit 310 supplies each memory block with a write enable signal WE and a write address WAD in sync with the vertical synchronizing signal Vs, horizontal synchronizing signal Hs, and dot clock signal DCLK. To be more specific, the write address control unit 310 counts up the dot clock signal DCLK and outputs the count result as the write address WAD, while outputting the write enable signal WE each time the value of the write address WAD is determined. Also, the count result of the write address control unit 310 is reset each time the vertical synchronizing signal Vs is inputted. Consequently, each of the memory blocks 321-327 is supplied with the write address WAD that sequentially accesses the memory space of m×n bits in each, whereby the sub-field data SD1-SD3 and SD5-SD7 is sequentially stored piece-by-piece at the addresses corresponding to the display positions within their respective memory blocks.

When each sub-field period starts, the display address control unit 330 outputs an address signal RAD that accesses bit data of a corresponding display row. The address signal RAD is incremented “n−1” times according to the number of display rows in sync with the clock signal CLX. Consequently, the address signal RAD such that sequentially accesses the bits from the first column to the n′th column with respect to the corresponding display row is outputted.

The read signals RD1-3 and RD5-7 are always enabled during the periods of their respective sub-fields SF1-SF3 and SF5-SF7, and switched OFF during the other sub-field periods. Consequently, only one corresponding memory block becomes readable in each of the sub-fields SF1-SF3 and SF5-SF7, and the readout from the other memory blocks is disabled. Consequently, when the sub-field SF1 starts, the sub-field data SD1 with m rows×n columns is read out sequentially from the memory block 321.

In the sub-fields SF2 and SF3, the memory blocks 322 and 323 are accessed in the same manner, and the sub-field data SD2 and SD3, each with m rows×n columns, is read out sequentially. Then, in the sub-field SF4, an ON signal S_on is held at the H level. The ON signal S_on is held at the L level during the periods other than the sub-field SF4. Then, in the sub-fields SF5-SF7, the memory blocks 325-327 are accessed in the same manner, and the sub-field data SD5 and SD7, each with m rows×n columns, is read out sequentially. The OR circuit 332 outputs an OR of the sub-field data SD1-SD3 and SD5-SD7 and the ON signal S_on as the data signal Ds.

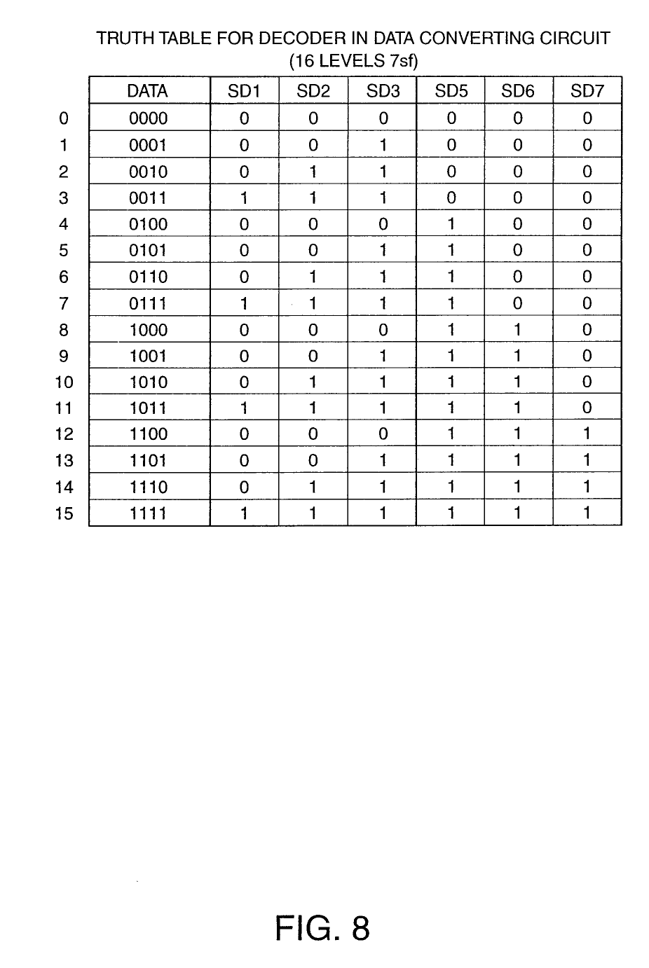

FIG. 8 shows a truth table that can be used with the decoder. The truth table the decoder 312 uses shows a correspondence between the grayscale data and a value “1” or “0” in the sub-field data (SD1-SD3 and SD5-SD7), which defines the ON/OFF states of the sub-fields SF1-SF3 and SF5-SF7. For example, in order to display the level 5 (0101), because the sub-field data SD3 and SD5 show “1”, the sub-fields SF3 and SF5 are switched ON.

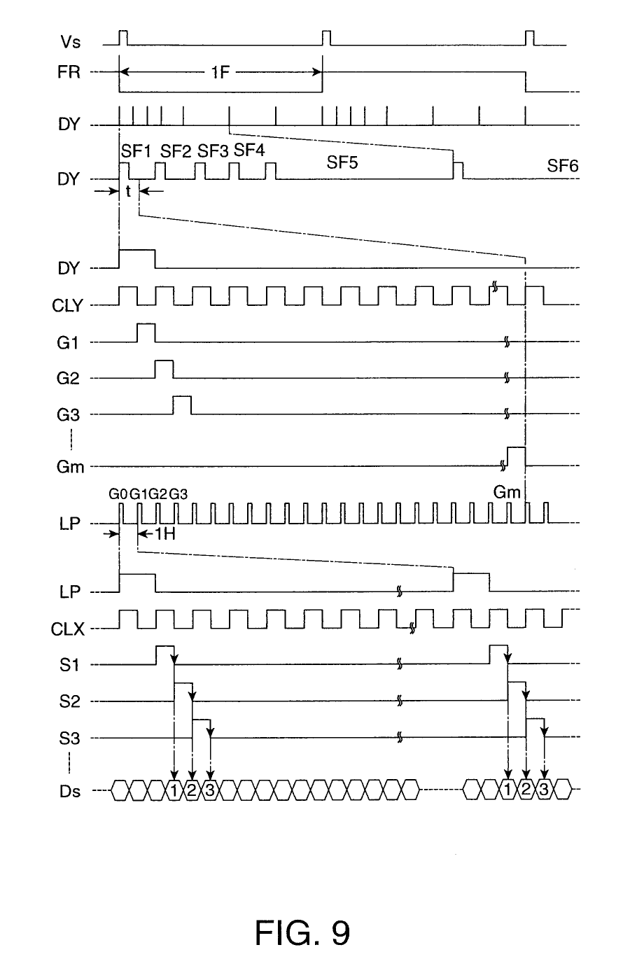

FIG. 9 shows waveforms of the signals in the first embodiment. In one frame (1F) where the alternating signal FR stays at the L level, upon supply of the start pulse DY, the scanning signals G1, G2, G3, . . . , and Gm are sequentially and exclusively outputted during a period (t) as being transferred by the scanning line driving circuit 130 according to the clock signal CLY. The period (t) is set shorter than the shortest sub-field SF1.

Each of the scanning signals G1, G2, G3, . . . , and Gm has a pulse width equivalent to half the period of the clock signal CLY, and the scanning signal G1 corresponding to the first scanning line 112 from the top is arranged in such a manner that it is outputted, after the start pulse DY is supplied, with a delay of at least half the period of the clock signal CLY since the clock signal CLY rises first. Hence, one shot (G0) of the latch pulse LP is supplied to the data line driving circuit 140 after the start pulse DY is supplied and before the scanning signal G1 is outputted.

Initially, when the one shot (G0) of the latch pulse LP is supplied to the data line driving circuit 140, the latch signals S1, S2, S3, . . . , and Sn are sequentially and exclusively outputted during a horizontal scanning period (1H) as being transferred by the data line driving circuit 140 according to the clock signal CLX. Each of the latch signals S1, S2, S3, . . . , and Sn has a pulse width equivalent to half the period of the clock signal CLX.

The first latch circuit 1404 in FIG. 4 latches the data signal Ds to the pixel 110 at the intersection of the first scanning line 112 from the top and the first data line 114 from the left at the fall of the latch signal S1, and then, latches the data signal Ds to the pixel 110 at the intersection of the first scanning line 112 from the top and the second data line 114 from the left at the fall of the latch signal S2, and thereafter, it latches the data signal Ds to the pixel 110 at the intersection of the first scanning line 112 from the top and the n′th data line 114 from the left in the same manner.

Consequently, initially the data signals Ds to the pixels of one row at the intersections on the first scanning line 112 from the top in FIG. 1 are latched dot-sequentially by the first latch circuit 1404. Herein, the data converting circuit 300 converts the grayscale data D0-D3 for each pixel into the data signal Ds at the latch timing of the first latch circuit 1404 and outputs the same. Subsequently, when the scanning line G1 is outputted as the clock signal CLY falls, the first scanning line 112 from the top in FIG. 1 is selected, and as a result, the transistor 116 in each pixel 110 at the intersection on that scanning line 112 is switched ON.

On the other hand, the latch pulse LP is outputted as the clock signal CLY falls. Then, at the falling timing of the latch pulse LP, the second latch circuit 1406 collectively supplies, through the potential selecting circuits 1408, the data lines 114 with the data signals Ds latched dot-sequentially by the first latch circuit 1404 in the form of the data signals d1, d2, d3, . . . , and dn, respectively.

For this reason, the data signals d1, d2, d3, . . . , and dn are written concurrently into the respective pixels 110 in the first row from the top.

In parallel with this writing operation, the data signals Ds to the respective pixels of one row at the intersections on the second scanning line 112 from the top in FIG. 1 are latched dot-sequentially by the first latch circuit 1404. Thereafter, the similar operation is repeated until the scanning signal Gm corresponding to the m′th scanning line 112 is outputted. In other words, during one horizontal scanning period (1H) where a scanning signal G1 (i is an integer satisfying 1≦i≦m) is outputted, the writing operation of the data signals d1, d2, d3, . . . , and dn into the respective pixels 110 of one row corresponding to the i′th scanning line 112, and the dot-sequential latching of the data signals Ds to the respective pixels 110 of one row corresponding to the (i+1)′th scanning line 112 are carried out in parallel. Herein, the data signals written into the pixels 110 are held therein until the writing operation in the next sub-field SF2.

Thereafter, the similar operation is repeated each time the start pulse DY that specifies the start of the sub-field is supplied. Further, when one frame has passed, the similar operation is repeated in each sub-field even when the alternating signal FR is reversed to the H level.

In the above-described first embodiment, even though a data signal with a voltage +V1 or −V1 instructing ON at the start of each sub-field is applied to the pixel electrode 118 (pixel writing by switching ON) by switching the transistor 116 ON, a kind of capacitivity due to holding the liquid crystal 105 between the pixel electrode 118 and the counter electrode 108 prevents the voltage of the pixel electrode 118 from actually immediately becoming the voltage of the data signal. Moreover, the ON period of the transistor 116 in each sub-field is extremely short compared with that in a normal driving in which the vertical scanning is made once in one frame. Thus, the voltage at the pixel electrode 118 of the pixel to be switched ON has a high possibility of being brought into a state of not reaching +V1 or −V1 only by one writing operation. In other words, it is assumed that, with an increase in the number of the pixel writing by switching ON in one frame, the voltage of the pixel electrode 118 approaches +V1 or −V1. Therefore, a level of grayscale of a pixel, which is to ideally depend on the total periods of sub-fields switched ON in one frame, strongly tends to also depend on the number of the pixel writing by switching ON in one frame.

However, in the first embodiment, the numbers of pixel writing by switching ON in one frame are, as shown by thick vertical lines at the starting period of each sub-field in FIG. 10, one, two, three and four for levels 0, 1, 2 and 3 of grayscale, respectively, and increase one by one in order as the level of grayscale increases. While, in the level 4 of grayscale, one level higher than the level 3 of grayscale, the number becomes two times so as to be changed conversely into reduction by two times. In the subsequent levels 5, 6, and 7 of grayscale, the number increases again in order as the level of grayscale increases. In the same way, compared with 5 times for the level 7 of grayscale, the number becomes 3 times for the level 8 of grayscale, and compared with 6 times for the level 11 of grayscale, the number becomes 4 times for the level 12 of grayscale, each of which results in reduction by two times. In other words, in the first embodiment, the number of pixel writing by switching ON for one frame does not necessarily increase with an increase in the level of grayscale.

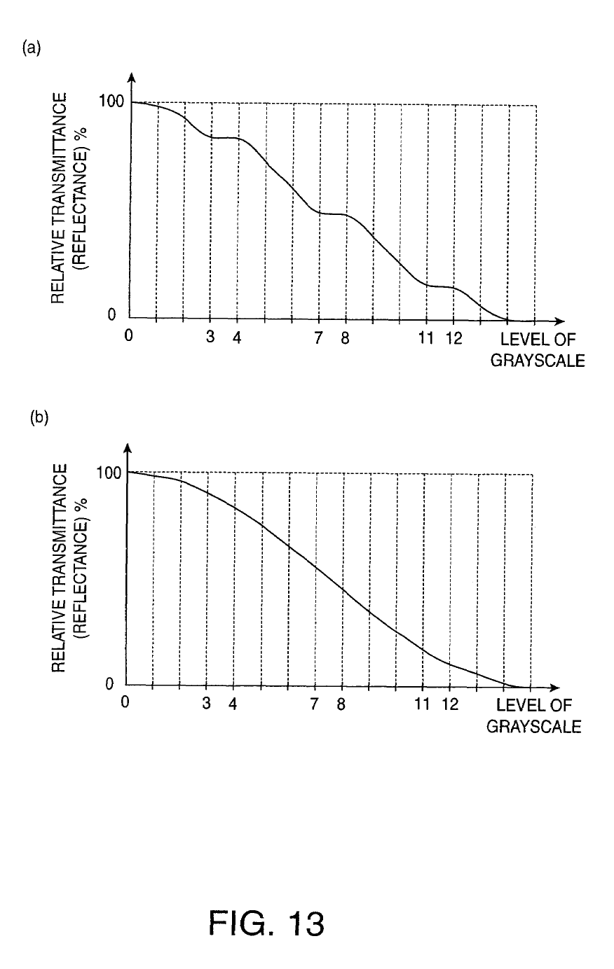

Therefore, in the first embodiment, the relationship between the actual level of grayscale by the pixel (transmittance or reflectance) and the level of grayscale instructed to the pixel (instructed level of grayscale) sometimes results in a staircase-like shape having partly flat portions as shown in FIG. 13(a). In detail, at instructed levels of 3 and 4 of grayscale, there occurs a phenomenon in which there is shown little difference between levels in transmittance or reflectance therefor. Similar phenomena occur between instructed levels 7 and 8, and between 11 and 12 of grayscale. Such a phenomenon causes a difference between the instructed level of grayscale and the actual level of grayscale to result in degradation in reproducibility characteristic of level of grayscale as a display device.

In order to prevent such degradation in reproducibility characteristic of level of grayscale, in the application example, setting of the sub-field defining an ON/OFF period of each pixel is improved as follows.

Namely, the improvement has been carried out in which, when grayscale data was divided into high-order bits and low-order bits, the second sub-fields, having a period length corresponding to weight of the least significant bit of the high-order bits and, along with this, having the number corresponding to the maximum value displayable by the high-order bits, were divided into two or more so that writing operations with the same details were executed in the divided sub-fields.

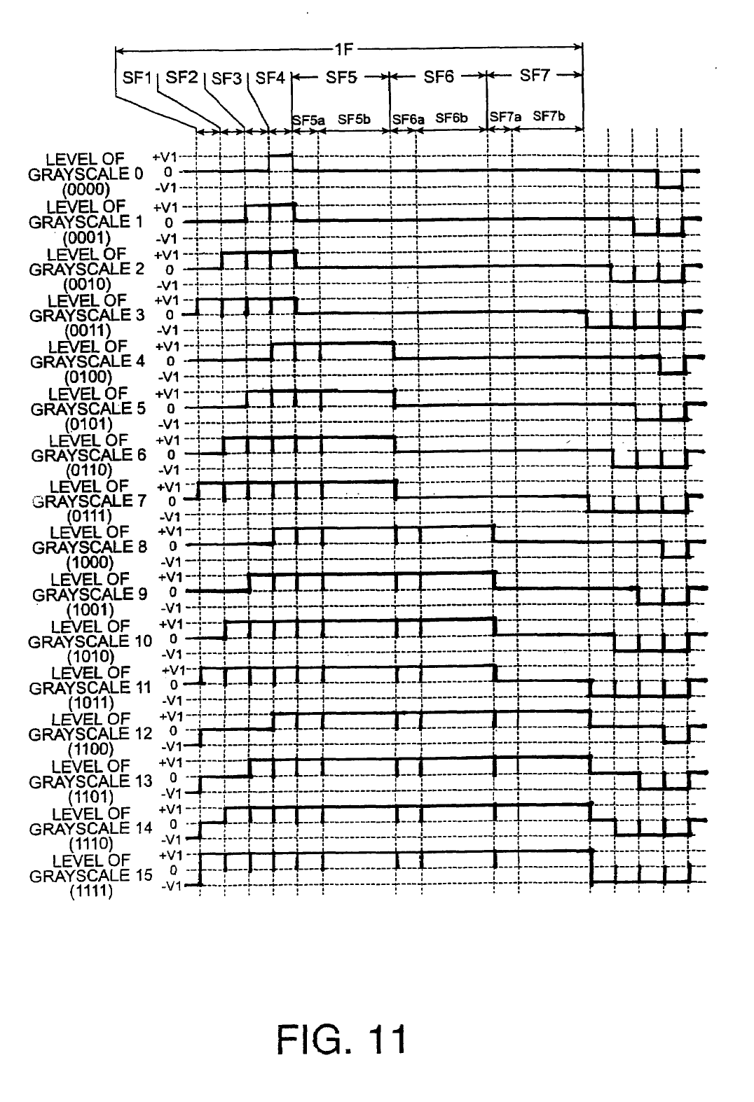

When such application example is applied to the above-described first embodiment, in which 4 bits grayscale data is divided into low-order 2 bits and high-order 2 bits, as shown in FIG. 11, the sub-field SF5, having a period length of “4” with a period length of each of the sub-fields SF1-SF3 taken as “1”, is divided into the sub-fields SF5a and SF5b having period lengths, for example, “1” and “3”, respectively. Along with this, writing operations with the same details are executed in the divided sub-fields. Similarly, the sub-fields SF6 and SF7 are divided into the sub-fields SF6a and SF6b, and SF7a and SF7b, respectively, with writing operations with the same details executed in the divided sub-fields.

With the sub-fields thus set, the number of pixel writing by switching ON in one frame becomes three in, for example, the level 4 of grayscale, 1 level higher than the level 3 of grayscale, and the number is reduced by only one time. In the same way, compared with six times in the level 7 of grayscale, the number becomes five times in the level 8, and further, compared with 6 times in the level 7 of grayscale, the number becomes 5 times in the level 8, and compared with 8 times in the level 11 of grayscale, the number becomes 7 times in the level 12, each with reduction by only one time.

Therefore, in the application example, it is possible to reduce dependence on the writing number in the actual level of grayscale (characteristic which an actual level of grayscale is dependent on not only total periods of sub-fields switched ON in one frame but also the number of pixel writing by switching ON).

As a result, in the relationship between the instructed level of grayscale and the level of grayscale by the actual pixel, as shown in FIG. 13(b), the partly flat portions are removed, by which it becomes possible to prevent degradation in reproducibility characteristic of level of grayscale.

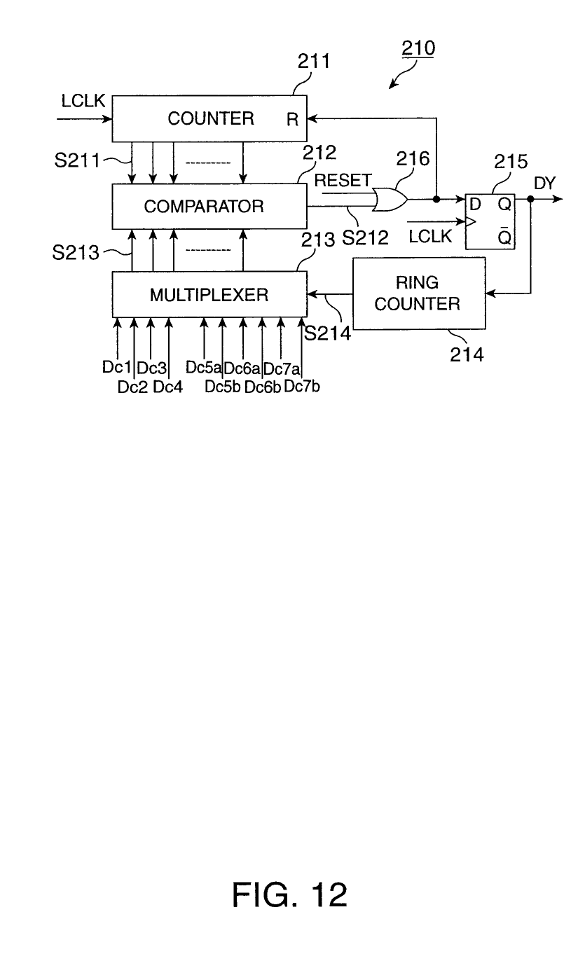

Here, the division of sub-fields can be easily achieved by arranging the start pulse generating circuit 210 as shown in FIG. 12 to output the above-described start pulse DY at the time of starting each of the divided sub-fields. Namely, an arrangement may be provided in which count data Dc5a, Dc5b, Dc6a, Dc6b, Dc7a, and Dc7b specifying the periods of time of the sub-fields SF5a, SF5b, SF6a, SF6b, SF7a, and SF7b, respectively, are supplied to the multiplexer 213 instead of the count data Dc5, Dc6, and Dc7 in FIG. 5 to allow the comparator 212 to compare a count value S211 of the counter 211 with an output data value S213 of the multiplexer 213, and to output a coincidence signal S212 at the H level when the two values coincide.

Moreover, in each of the sub-fields SF5a and SF5b, the data signal Ds may be supplied which is the same as that supplied to the sub-field SF5 before being divided. Thus, the display address control unit 330 may output the address signal RAD two times to the memory block 325 over the sub-fields SF5a and SF5b. Similarly, the display address control unit 330 may output the address signal RAD two times to the memory block 326 over the sub-fields SF6a and SF6b, and two times to the memory block 327 over the sub-fields SF7a and SF7b.

Furthermore, each of the second sub-field periods SF5, SF6, and SF7, each corresponding to weight represented by high-order 2 bits of the grayscale data, may be divided, for example, into three instead of being divided into two. Moreover, instead of dividing the second sub-field period equally into two, the second sub-field periods may be divided with the numbers of division made therein to differ from one another such that, for example, a certain second sub-field is divided into two and another second sub-field period is divided into three.

When the numbers of division are made to differ among the second sub-fields, it is preferable that the number of division of a sub-field corresponding to a certain bit of the high-order bits is set so as not to be larger than the numbers of division of sub-fields corresponding to lower-order bits than the above bit. In other words, about the number of division of the second sub-field, it is preferable that the number is set so as to become larger in the second sub-field nearer the boundary (the reference point) with the first sub-field (that is, as the weight of the corresponding bit is smaller).

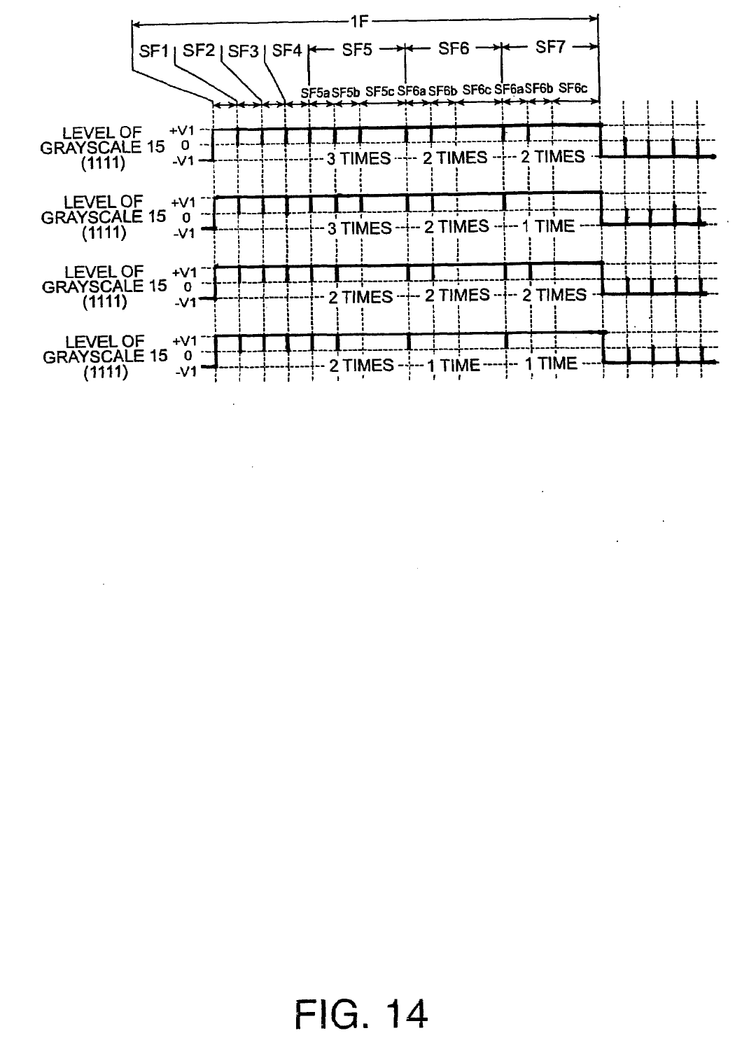

For example, about the numbers of division of the sub-fields SF5, SF6, and SF7 in the above application example, it is preferable that the numbers of division are set as SF5≧SF6≧SF7 as illustrated in FIG. 14. Here, in FIG. 14, with the period length of each of the sub-fields SF1-SF3 taken as “1”, the sub-field SF5 having a period length “4” is divided into sub-fields SF5a, SF5b, and SF5c having period lengths “1”, “1”, and “2”, respectively. About the sub-fields SF6 and SF7, each of them are similarly divided into three. It is possible to make such a division into three by changing count data supplied to the multiplexer 213 in the start pulse generating circuit 210 and, along with this, by controlling access in the display address control circuit 330 as explained in the above application example.

The reason for thus setting the number of division of the second sub-field so as to become larger in the second sub-field nearer the boundary with the first sub-field is as follows. That is, the ON period of the transistor 116 in each sub-field is extremely short compared with that in a normal driving in which the vertical scanning is made once in one frame. Thus, the voltage in the pixel electrode 118 of the pixel to be switched ON is brought into a state of not reaching +V1 or −V1 only by one writing operation. This sometimes occurs particularly in a state at a low temperature. In other words, it is assumed that, with an increase in the number of the pixel writing by switching ON in one frame, the voltage of the pixel electrode 118 approaches +V1 or −V1 to saturate at a certain number. Therefore, the number of division is made larger near the boundary with the second sub-field and, when the number of writing reaches that for near saturation, no more increase in the number of writing may be necessary.

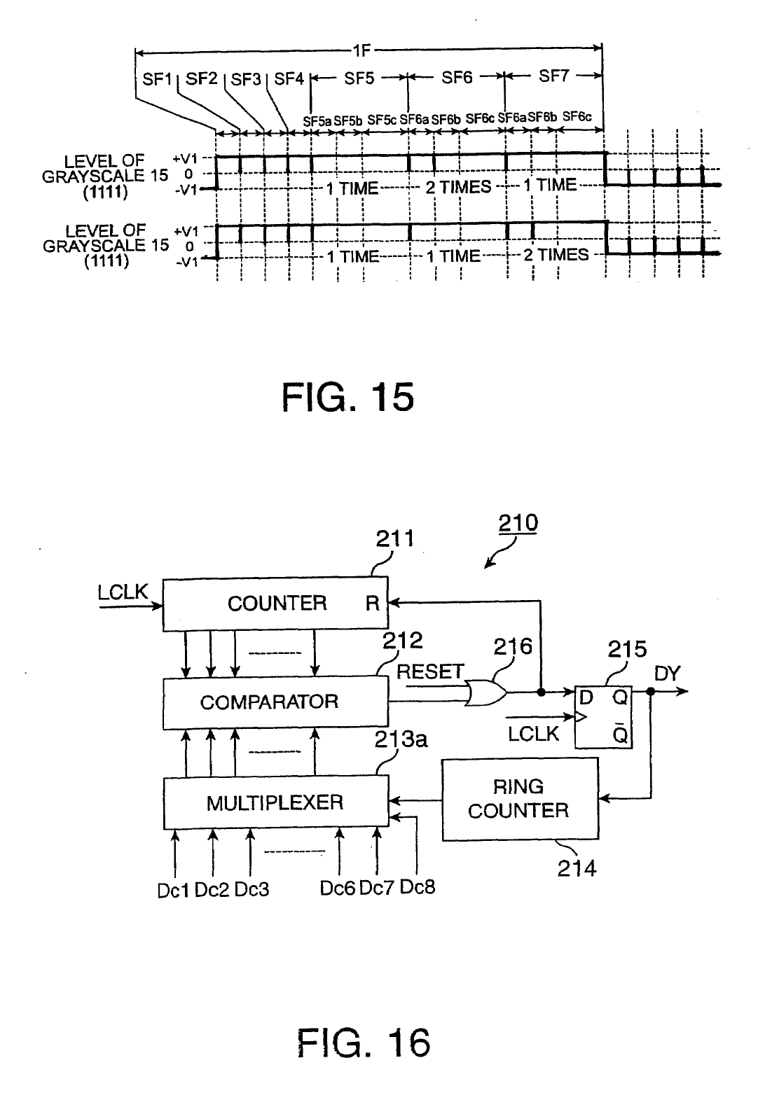

Furthermore, regarding the division of the second sub-field, the above reason is not necessarily to be considered. For example, as shown in FIG. 15, only the second sub-field period SF6 situated in the middle of the second sub-field periods SF5-SF7 may be divided without dividing the remaining second sub-field periods SF5 and SF7. In another way, of the second sub-field periods SF5-SF7, only the second sub-field period SF7 situated farthest from the boundary may be divided without dividing the remaining second sub-field periods SF5 and SF6. That is, of the second sub-field periods SF5-SF7, only one of the second sub-field periods may be divided.

The dividing ratios of the second sub-field may be any ones other than those shown in FIG. 11, FIG. 14, and FIG. 15. For example, a sub-field with a period length of “4” may be divided into as “1.2” and “2.8”.

However, in connection with the period length of each of the sub-fields SF1 to SF4 being “1”, it is considered to be more advantageous than the above to set the period length of the sub-field SF5a, SF5b, or the like to a period length as an integral multiple of the above period length, that is, to provide the length of the divided period of the second sub-field with a period length of any one of the first sub-field period length taken as a unit, in that no count data accompanied with decimals is necessary to be supplied to the multiplexer 213.

The following description will describe an electro-optic device of a second embodiment with reference to FIGS. 16 through 19.

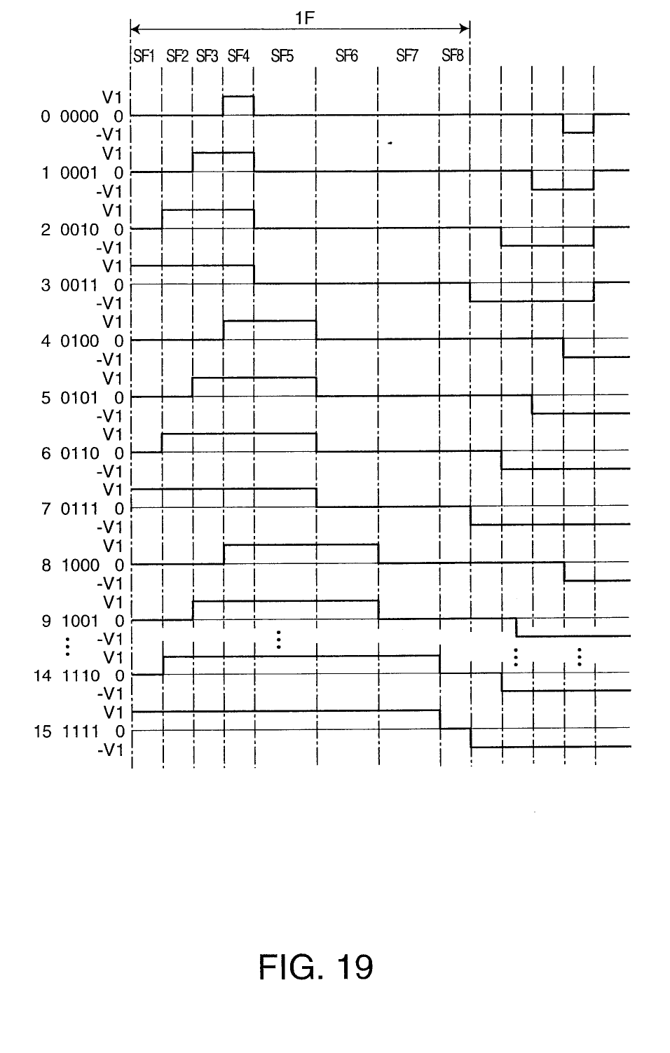

FIG. 19 shows sub-fields in the second embodiment. As is apparent from the comparison of FIG. 19 with FIG. 10 showing the sub-fields in the first embodiment, a sub-field SF8 that is always kept switched OFF regardless of the grayscale data is additionally provided in a frame 1F in the second embodiment.

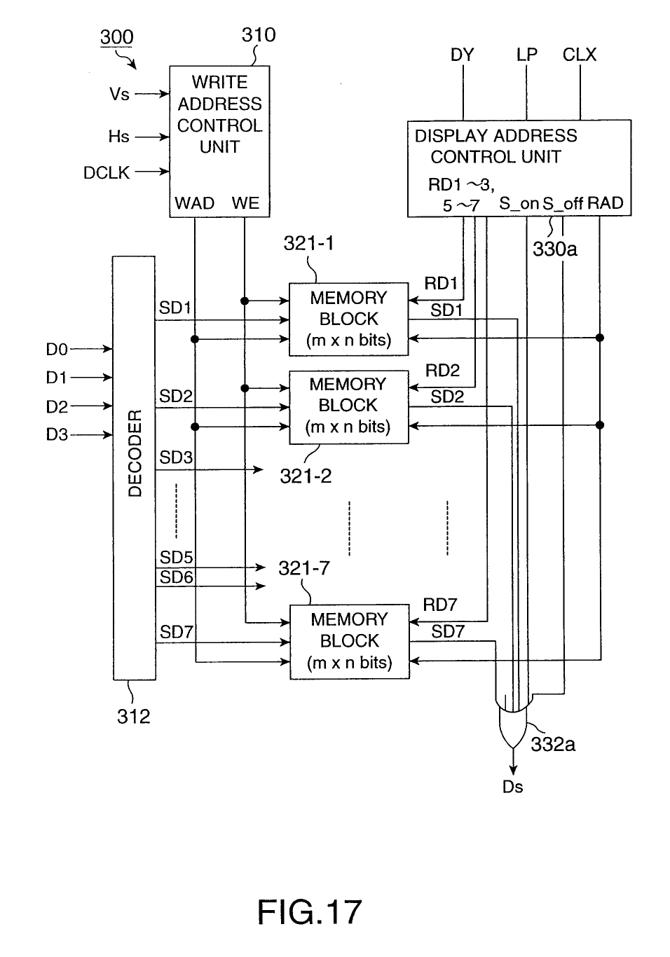

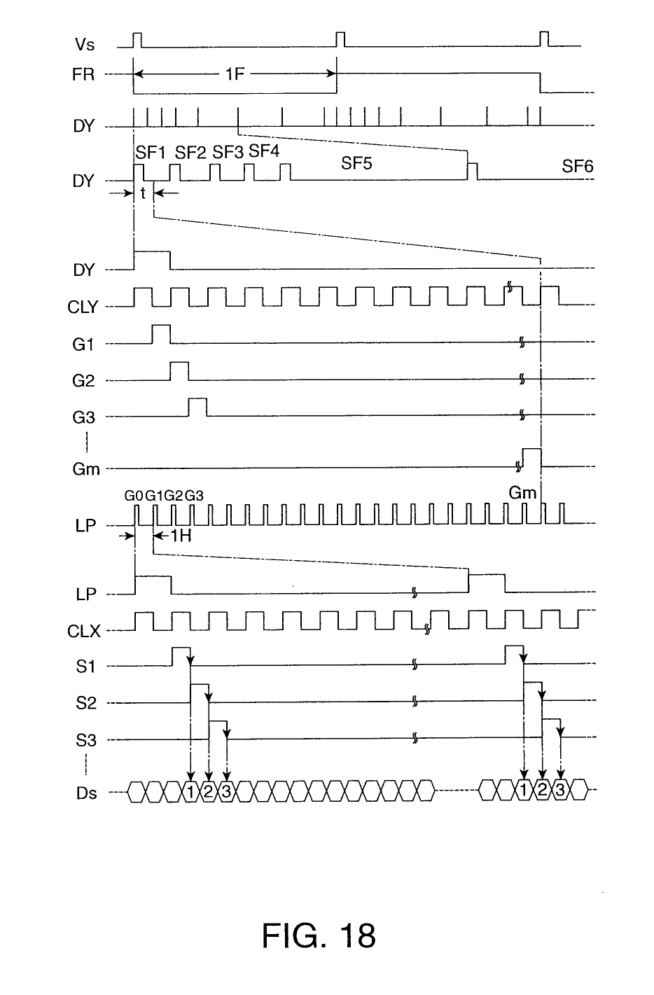

FIG. 16 shows an arrangement of a start pulse generating circuit of the second embodiment. FIG. 17 shows an arrangement of a data converting circuit of the second embodiment. FIG. 18 shows waveforms of signals in the second embodiment. The electro-optic device of the second embodiment can include the start pulse generating circuit 210 shown in FIG. 16 and the data converting circuit 300 shown in FIG. 17 so as to operate by using the sub-field SF8. In the start pulse generating circuit 210, as shown in FIG. 16, a multiplexer 213a is supplied with count data Dc8 to generate a period corresponding to the sub-field SF8. In the data converting circuit 300, as shown in FIG. 17, a display address control unit 330a outputs an S_off signal only when the start pulse DY specifies the sub-field SF8.

According to the electro-optic device of the second embodiment, when the period of any of the sub-fields SF1-SF7 needs to be slightly increased or decreased for fine-tuning the level of grayscale, it is possible to fine-tune the level of grayscale by merely increasing or decreasing the period of the sub-field SF8 as long as necessary without increasing or decreasing the length of the other sub-fields SF1-SF3 and SF5-SF7, thereby making the fine-tuning of the level of grayscale easier.

An electro-optic device of a third embodiment is characterized by displaying a greater number of levels of grayscale than the electro-optic devices of the first and second embodiments. The following description will describe the electro-optic device of the third embodiment with reference to FIGS. 15 through 18.

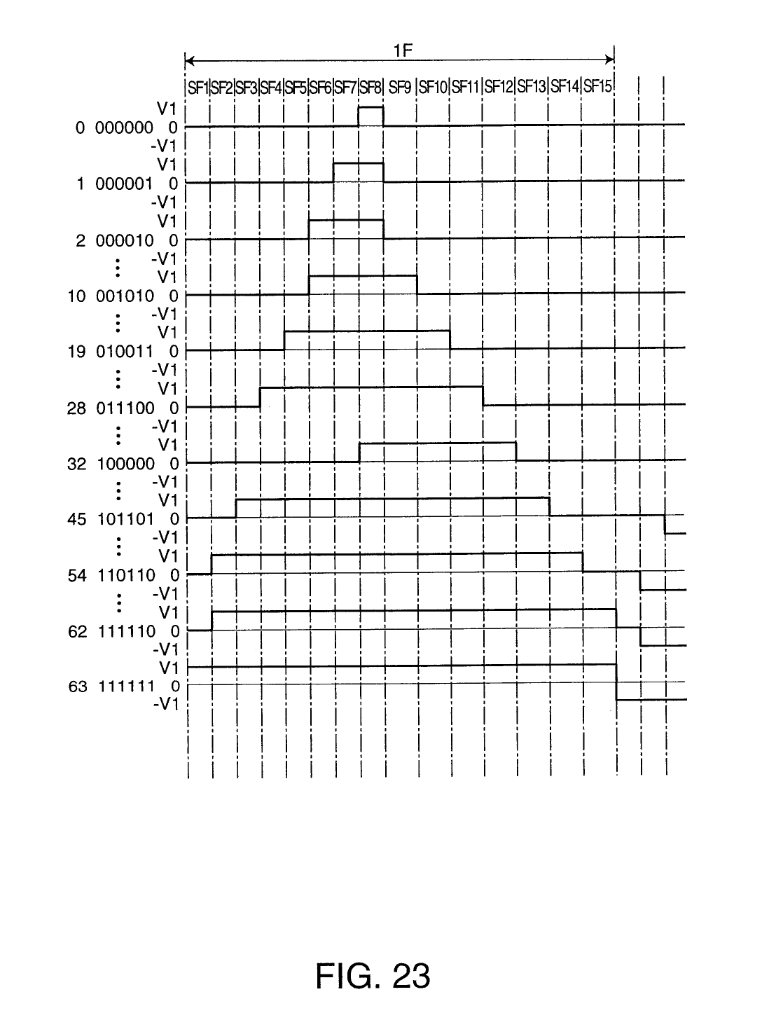

FIG. 23 shows sub-fields in the third embodiment. According to the electro-optic device of the third embodiment, in order to display 64-level grayscale defined by 6-bit grayscale data D0-D5 inputted into the electro-optic device, one frame (1F) includes, as shown in FIG. 23, seven sub-fields SF1-SF7, seven sub-fields SF9-SF15, and a sub-field SF8. The length of the sub-fields SF1-SF7 has a weight for the level 1, and the length of the sub-fields SF9-SF15 has a weight for the level 8. In order to give a threshold voltage Vth that is defined by the performance characteristics of the liquid crystals, the sub-field SF8 is always kept switched ON regardless of a level of grayscale.

The ON/OFF state of the sub-fields SF1-SF7 is defined by low-order three bits (D0-D2) in the grayscale data D0-D5, whereas the ON/OFF state of the sub-fields SF9-SF15 is defined by high-order three bits (D3-D5) in the grayscale data D0-D5. For example, given “001010” that defines the level 10 as the grayscale data D0-D5, then the sub-fields SF6 and SF7 are switched ON and the sub-field SF9 is also switched ON, and given “011100” that defines the level 28 as the grayscale data D0-D5, then the sub-fields SF4-SF7 are switched ON and the sub-fields SF9-SF11 are also switched ON.

In this manner, by sequentially selecting the sub-fields SF1-SF7 and the sub-fields SF9-SF15 along the outward direction of the frame from the substantial boundary between the sub-fields SF7 and SF9, which is given as the origin, in accordance with an increase in the value of the low-order bits (D0-D2) and an increase in the value of the high-order bits (D3-D5), it is possible to secure the continuity of the selected sub-fields as is in the first embodiment.

It should be appreciated, however, that the 6-bit grayscale data D0-D5 may be divided into, for example, high-order two bits and low-order four bits instead of being divided into two sets of three bits.

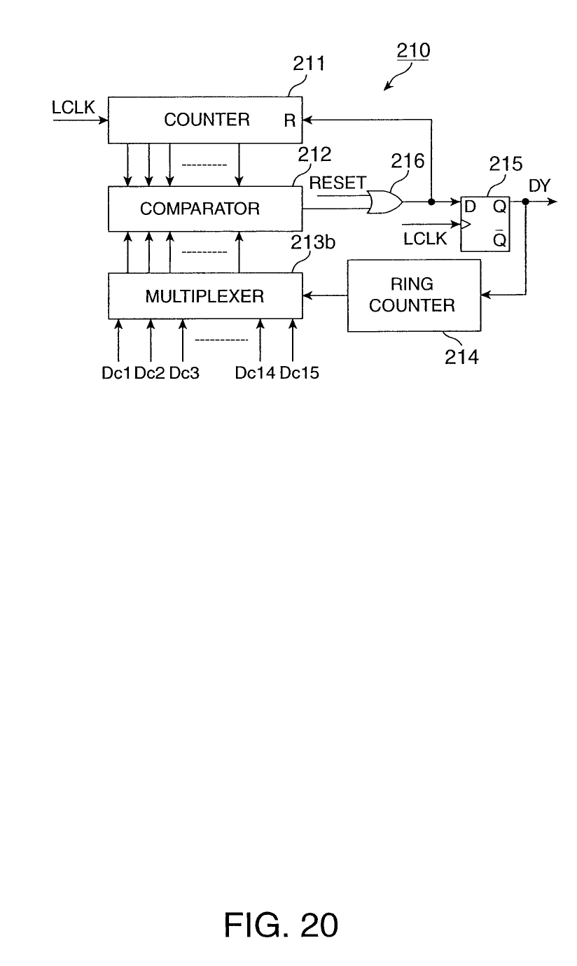

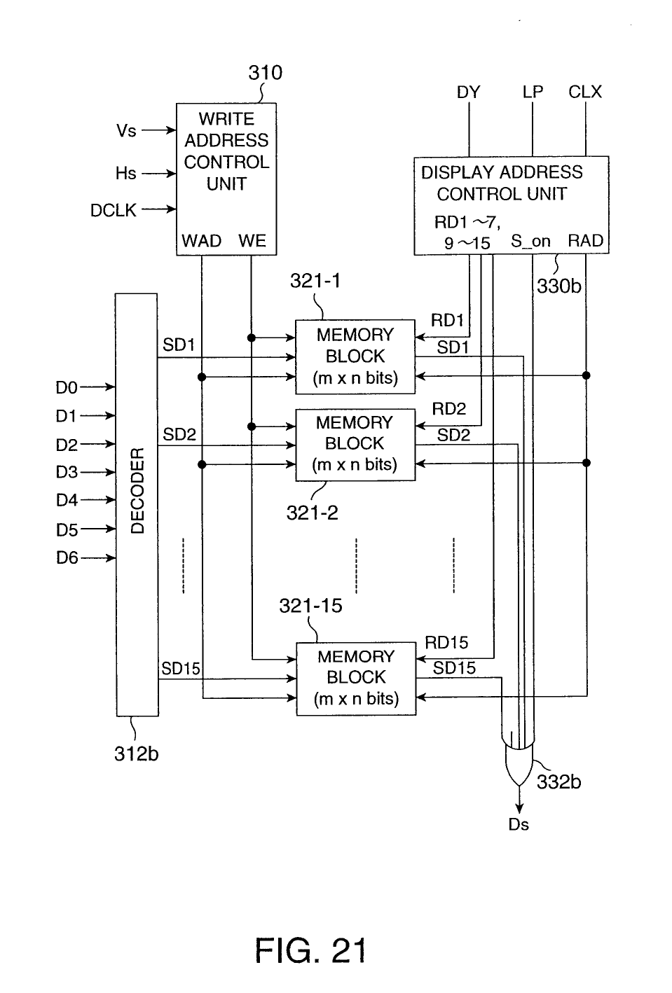

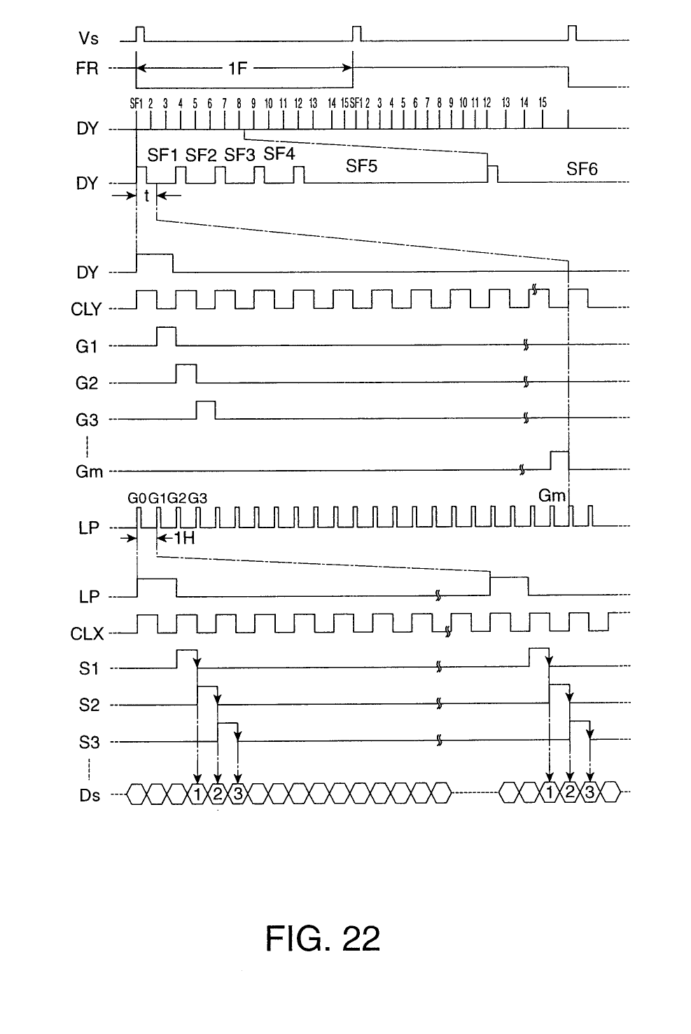

FIG. 20 shows an arrangement of a start pulse generating circuit of the third embodiment. FIG. 21 shows an arrangement of a data converting circuit of the third embodiment. FIG. 22 shows an operation of the electro-optic device of the third embodiment. In order to perform the above operation, the electro-optic device of the third embodiment includes the start pulse generating circuit shown in FIG. 20 and the data converting circuit shown in FIG. 21.

In the start pulse generating circuit 210, as shown in FIG. 20, a multiplexer 213b is supplied with count data Dc1-Dc15 to generate periods corresponding to the sub-fields SF1-SF15, respectively. In the data converting circuit 300, as shown in FIG. 21, a decoder 312b is supplied with the grayscale data D0-D6 and outputs sub-field data SD1-SD7 and SD9-SD15, while a display address control unit 330b outputs readout signals RD1-RD7 and RD9-RD15 each time the start pulse DY specifies the sub-fields SF1-SF15, respectively.

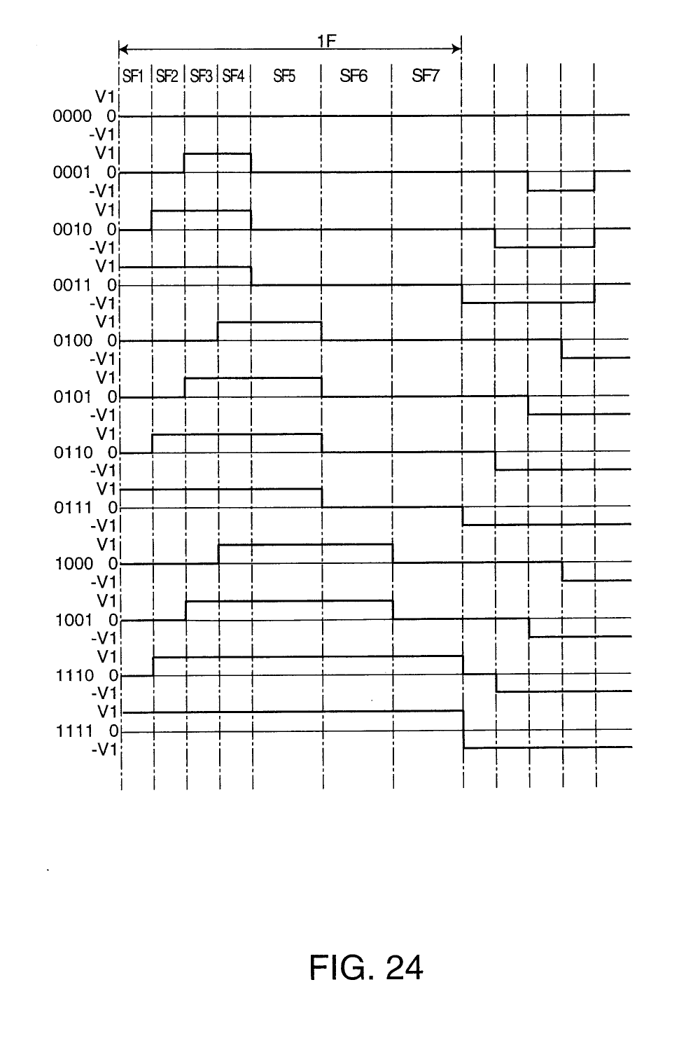

The following description will describe an electro-optic device of a fourth embodiment with reference to FIG. 24. FIG. 24 shows sub-fields in the fourth embodiment. As shown in FIG. 24, the electro-optic device of the fourth embodiment, as a rule, switches ON the sub-field SF4, which was described in the first embodiment as the sub-field that should be always kept switched ON regardless of the grayscale data, and switches OFF the same only when “0000” is given as the grayscale data. Consequently, it is possible to improve a contrast, and hence the image quality.

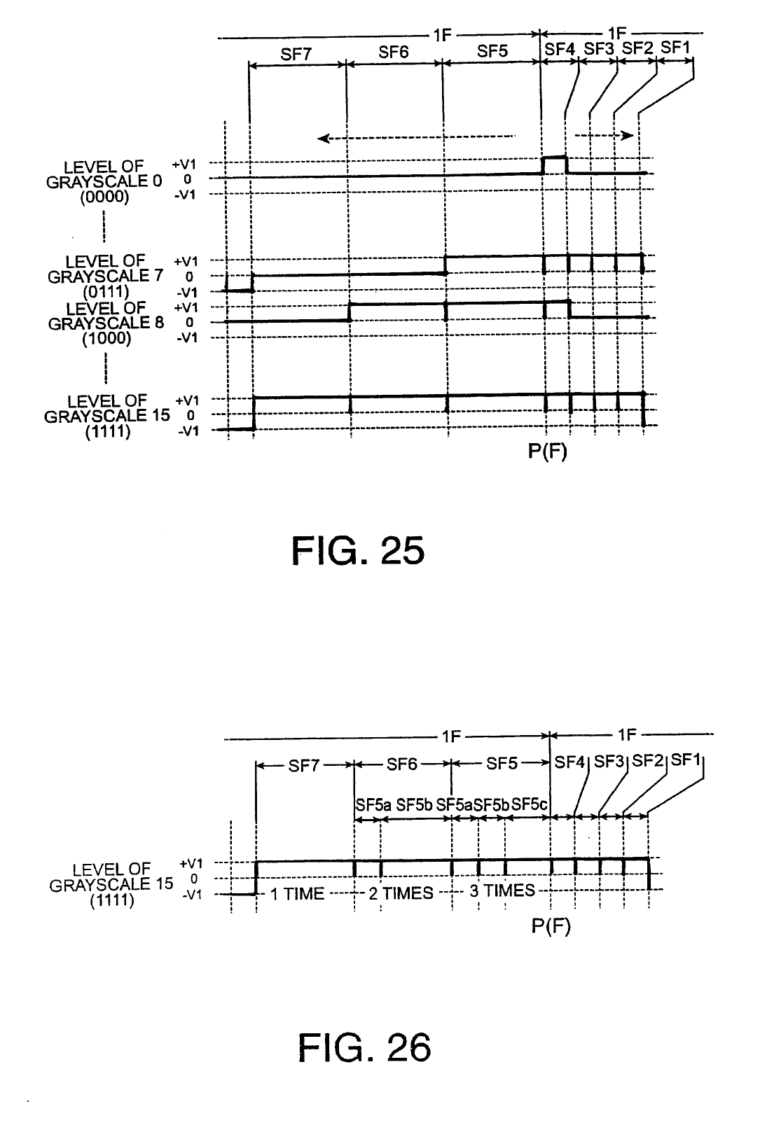

An electro-optic device of a fifth embodiment will be explained with reference to FIG. 25. FIG. 25 shows sub-fields in the fifth embodiment. As shown in FIG. 25, the electro-optic device of the fifth embodiment makes the sub-fields, to be selected according to a level of grayscale, continuous at a boundary F between the frames adjacent to each other. In other words, the sub-fields are constituted so that a boundary P (reference point) in sequentially selecting the first sub-fields and the second sub-fields according to a level of grayscale coincides with the boundary F between the frames.

With this, the first sub-fields (SF1-SF3) are sequentially selected in descending order from the boundary with respect to the time axis and the second sub-fields (SF5-SF7) are sequentially selected in ascending order from the boundary with respect to the time axis according to levels of grayscale, with each selection being made in the direction opposite to that in the first embodiment. That is, in the fifth embodiment, the selection of sub-fields is to be seemingly made toward the middle of each of the front and rear frames.

Therefore, although the fifth embodiment differs from other embodiments in that selection of sub-fields is carried out over two frames adjacent to each other, the continuity of the sub-fields is secured. Thus, like in the other embodiments, it becomes possible to avoid the occurrence of a defect in a level of grayscale.

In addition, when the technology according to the application example of the above-explained first embodiment (that is, the technology of dividing the second sub-fields into two or more) is applied to the fifth embodiment, the sub-fields become as shown in FIG. 26, for example. That is, since the numbers of division in the second sub-fields are set so as to become larger in those nearer the boundary P with the first sub-fields, the numbers of division in the sub-fields SF5, SF6, and SF7, although being arranged in reverse in the direction of the time axis, becomes, similarly in the above application example, 3, 2, and 1, respectively, for example.

The following description will describe an electro-optic device of a sixth embodiment with reference to FIGS. 21 through 25. The electro-optic device of the sixth embodiment is characterized in that the technique of securing the continuity of the selected sub-fields described in the first through fifth embodiments above is combined with FRC (Frame Rate Control) modulation.

The FRC modulation realizes a grayscale display not throughout one frame period, but throughout a plurality of frames continuous with respect to one another. For example, when the level 11 in the 64-level grayscale is displayed by using two continuous frames, the level 6 is displayed in the first frame and the level 5 is displayed in the second frame. Also, for example, when the level 11 in the 64-level grayscale is displayed by using three continuous frames, the level 4 is displayed in the first frame, the level 4 is displayed in the second frame, and the level 3 is displayed in the third frame. As the number of the levels to be displayed increases to 64 to 128 and to 256, the sub-field displaying a low level of grayscale, for example, the sub-field having the length corresponding to the level 1, has to be shorter. Hence, the FRC modulation is particularly suited in controlling the ON/OFF operation of the sub-field displaying a low level of grayscale with a high accuracy.

For example, assume that N bits forming the grayscale data is composed of high-order M bits (M is a positive integer less than N) and low-order (N−M) bits, and first sub-fields have a first weight equivalent to the weight assigned to the least significant bit in the low-order (N−M) bits, and second sub-fields have a second weight equivalent to the weight assigned to the least significant bit in the high-order M bits, and F is given as the number of the plurality of frames. Then, the number b of the first fields and the number c of the second fields in each frame are expressed, respectively, by

b=(2^{N-M}−1)/F (1),

and

c=(2^{M}−1) (2),

where, when (2^{N-M}−1) is not divisible by F (leaves a remainder) in the expression (1), the number b is taken as a number for which 1 is added to the integer part of the quotient as an exception.

Further, assuming that the first weight is α, the second weight β is expressed by

β=α2^{N-M}/F (3).

Moreover, about one frame, the number Z of selection patterns expressing combination of selection/nonselection of the first sub-fields and the second sub-fields is expressed by

Z=2^{M}(b+1) (4).

Further, it is preferable to divide the grayscale data into the high-order bits and the low-order bits on the basis of optimal solution of M such that gives a smallest total number of the first and second sub-fields.

About the above expressions (1), (2), and (4), no consideration is taken into the sub-fields that should be always kept in a switched ON state and the sub-field that should be always kept in a switched OFF state.

In the following, explanation will be made about 64-level grayscale 3FRC that displays 64-level grayscale, defined by 6 bit grayscale data, by using three continuous frames, with the case of dividing the grayscale data into high-order two bits and low-order four bits taken as an example.

In this case, N, M, and F are given as N=6, M=2, and F=3, respectively. Then, there are derived from the above expressions (1), (2), (3), and (4) as b=5, c=3, β=5.33α, and Z=24.

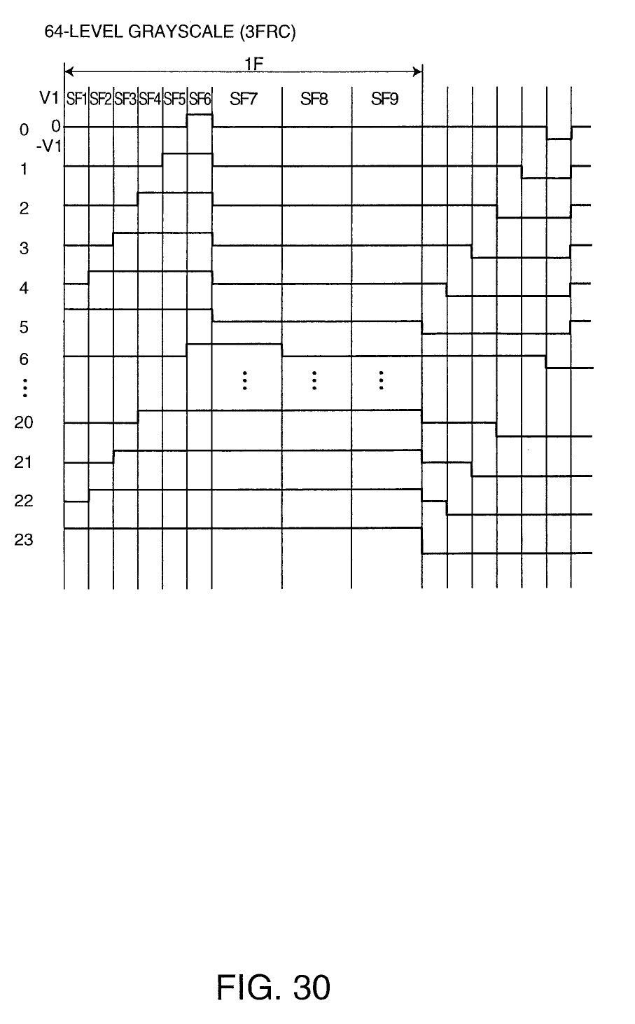

About the state, explanation will be made with reference to FIG. 30. As a result of distributing fifteen sub-fields in three frames for displaying 16-level grayscale to be presented by low-order four bits of the grayscale data through the three frames, five (b=5) sub-fields SF1-SF5, each having a weight assigned to the least significant bit, are provided in each frame.

While, each frame is provided with three (c=3) sub-fields SF7-SF9 each of which is equivalent to the weight assigned to the least significant bit of high-order two bits of the grayscale data. In detail, for the weight assigned to the least significant bit of grayscale data made as “1”, the weight assigned to the least significant bit of high-order two bits of the grayscale data becomes “16”. As a result of distributing the weight in the three frame, the period length of each of the sub-fields SF7-SF9 becomes “5.33” (with the period length of each of the sub-fields SF1-SF5 taken as “1”).

That is, in each frame, there are provided a total of nine sub-fields, the sub-fields SF1-SF5 corresponding to the low-order four bits, the sub-fields SF7-SF9 corresponding to the high-order two bits, and the sub-field SF6 that should be always kept switched ON.

In FIG. 30, it is shown that there are five sub-fields SF1-SF5 corresponding to the low-order bits, while there are three sub-fields SF7-SF9 corresponding to the high-order bits, which results in 24 (=(5+1)×(3+1)) kinds of selection patterns. This is also apparent from Z being obtained as Z=24.

FIG. 31 is a chart showing selection patterns that are to be selected in each frame in the case of the 64-level grayscale 3FRC. For example, when the grayscale data defines the level 7 (000111), then in the first frame, of all the sub-fields included in the first frame, the sub-fields necessary to form a selection pattern 3 shown in FIG. 30 are selected, that is, the sub-fields SF3-SF5 are selected. In the second frame, of all the sub-fields included in the second frame, the sub-fields necessary to form a selection pattern 2 shown in FIG. 30 are selected, that is, the sub-fields SF4 and SF5 are selected. Also, in the third frame, of all the sub-fields included in the third frame, the sub-fields necessary to form the selection pattern 2 are selected, that is, the sub-fields SF4 and SF5 are selected.

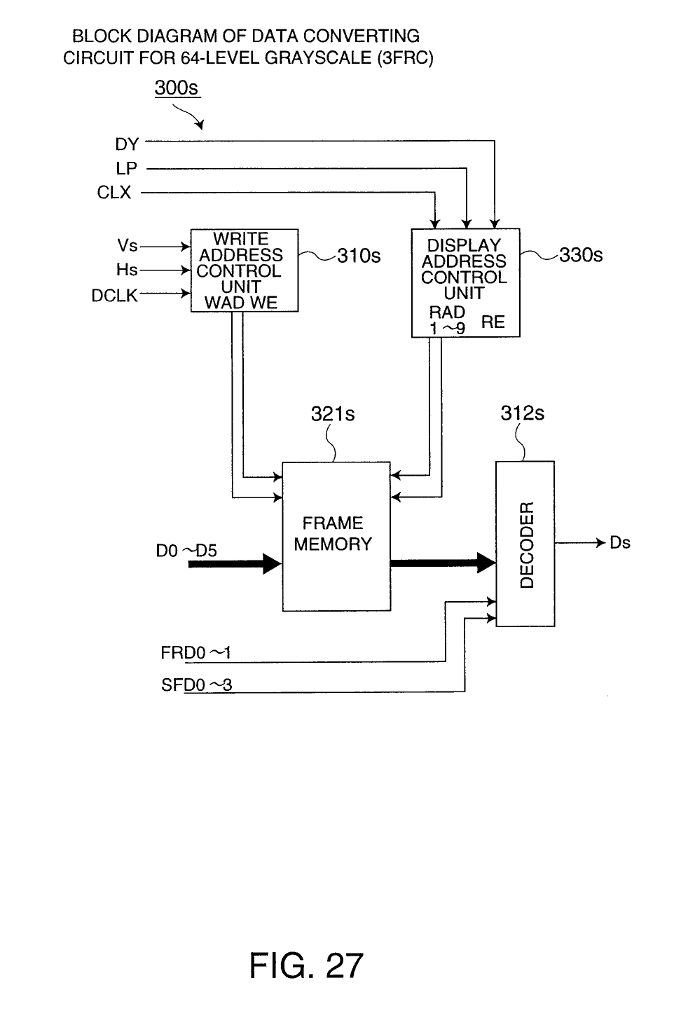

FIG. 27 is a diagram showing an arrangement of a data converting circuit for the 64-level grayscale 3FRC. As shown in the diagram, the data converting circuit 300s includes, like the counterpart in the first embodiment above, a write address control unit 310s, a display address control unit 330s, a frame memory 321s, and a decoder 312s.

The grayscale data D0-D5 are once written into an address indicated as a writing address WAD of the storing region of the frame memory 321s before being read out from an address indicated as a reading out address RAD, and are outputted to the decoder 312s.

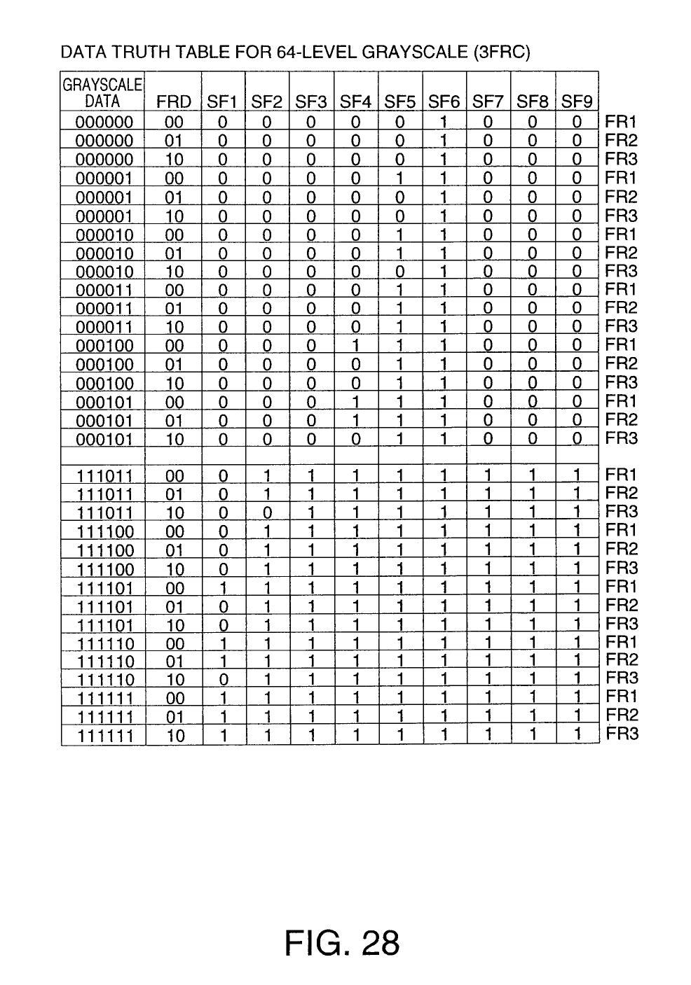

The decoder 312s decodes the grayscale data into the data signal Ds in compliance with sub-field periods specified by sub-field numbers specified by signals SFD0-SFD3 (in detail, according to the truth table shown in FIG. 28) of frame numbers specified by signals FRD0 and FRD1.

According to the data converting circuit 300s, the grayscale data (000001) defining the level 1 of grayscale is converted to the data signal Ds of “1” instructing that the pixel is to be switched ON, when the first frame FRI of the three frames is specified by the signals FRD0 and FRD1, and the sub-field SF5 of the sub-fields SF1-SF9 is specified by the signals SFD0-SFD3.

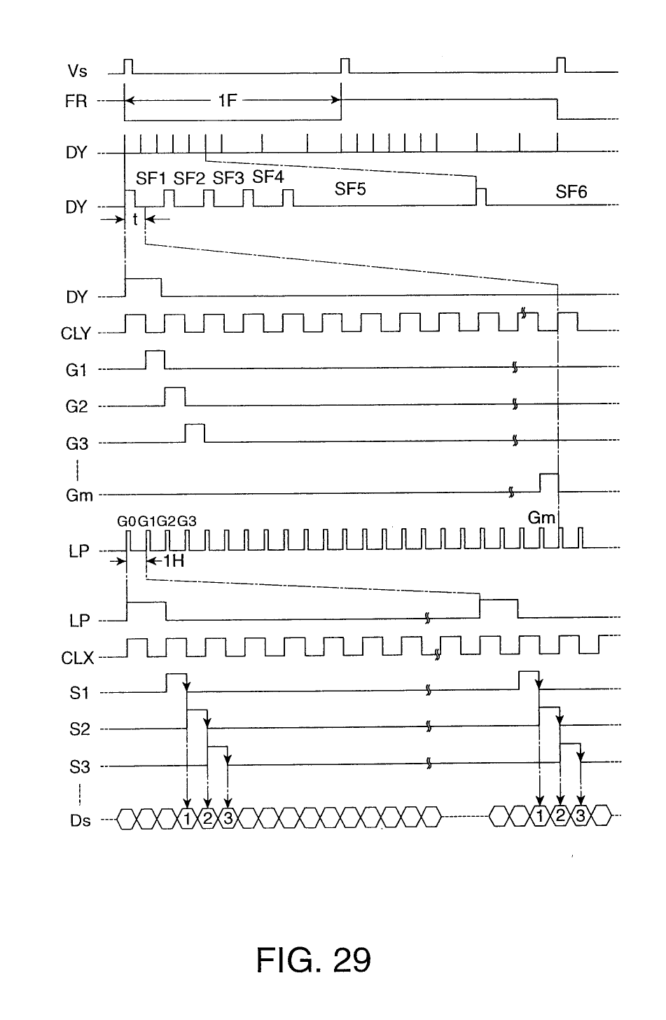

FIG. 29 shows waveforms of signals for the 64-level grayscale 3FRC in the sixth embodiment. The waveforms of the signals shown in FIG. 29 are substantially identical with the waveforms of the signals in the first embodiment.

Next, explanation will be made about the case, in which, with respect to 64-level grayscale 2FRC, displaying 64-level grayscale defined by 6 bit grayscale data by using two frames, the grayscale data is divided into high-order three bits and low-order three bits.

In this case, N, M, and F become as N=6, M=3, and F=2, respectively. Then, there is derived from the exception of the above expression (1) as b=4, and there are derived from the above expressions (2), (3), and (4) as c=7, β=4α, and Z=40.

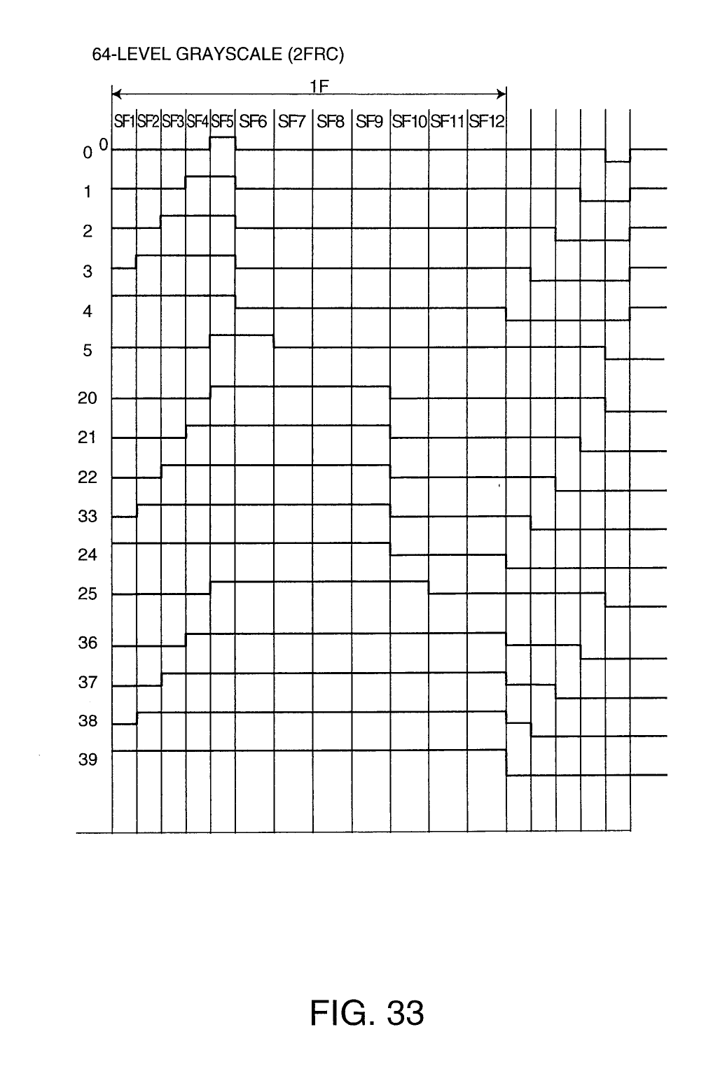

About the state, explanation will be made with reference to FIG. 33. There are provided in each frame four (b=4) sub-fields SF1-SF4 each having a weight assigned to the least significant bit of the grayscale data. While, each frame is provided with seven (c=7) sub-fields SF6-SF12 each of which is equivalent to the weight assigned to the least significant bit of high-order three bits of the grayscale data.

Moreover, with the period length of each of the sub-fields SF1-SF4 taken as “1”, the period length of each of the sub-fields SF6-SF12 becomes “4”.

That is, in each frame, there are provided a total of twelve sub-fields, four sub-fields SF1-SF4 corresponding to the low-order three bits, seven sub-fields SF6-SF12 corresponding to the high-order three bits, and the sub-field SF5 that should be always kept switched ON.

Therefore, selection patterns in one frame becomes 40 (=(4+1)×(7+1)) kinds as shown in FIG. 33. This is also apparent from Z being obtained as Z=40.

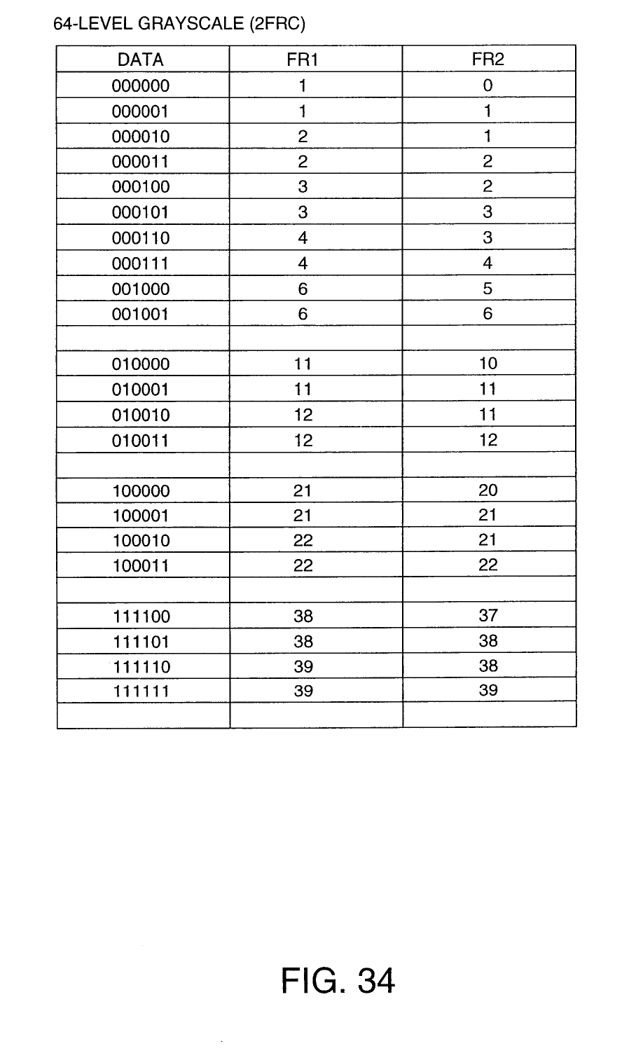

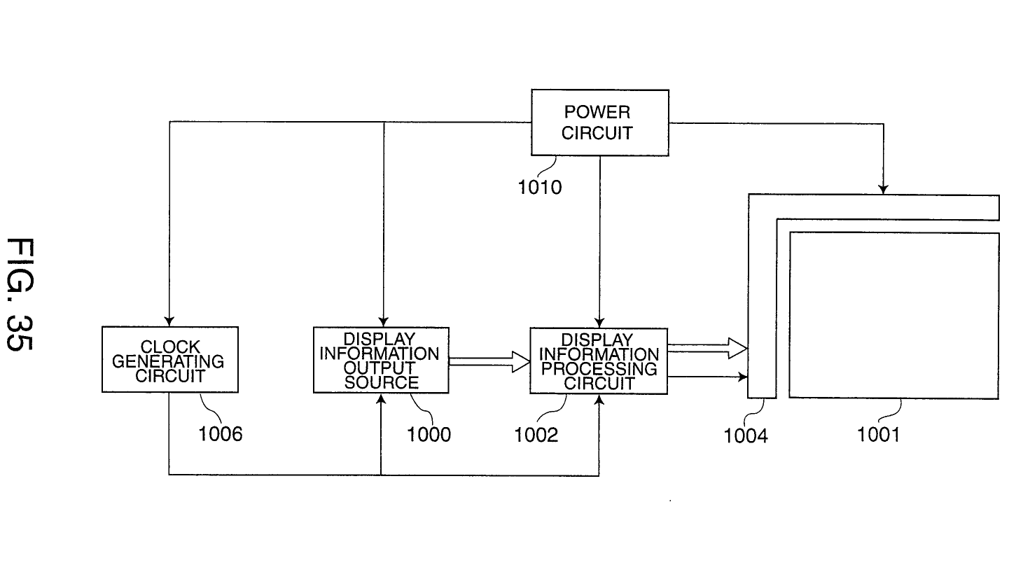

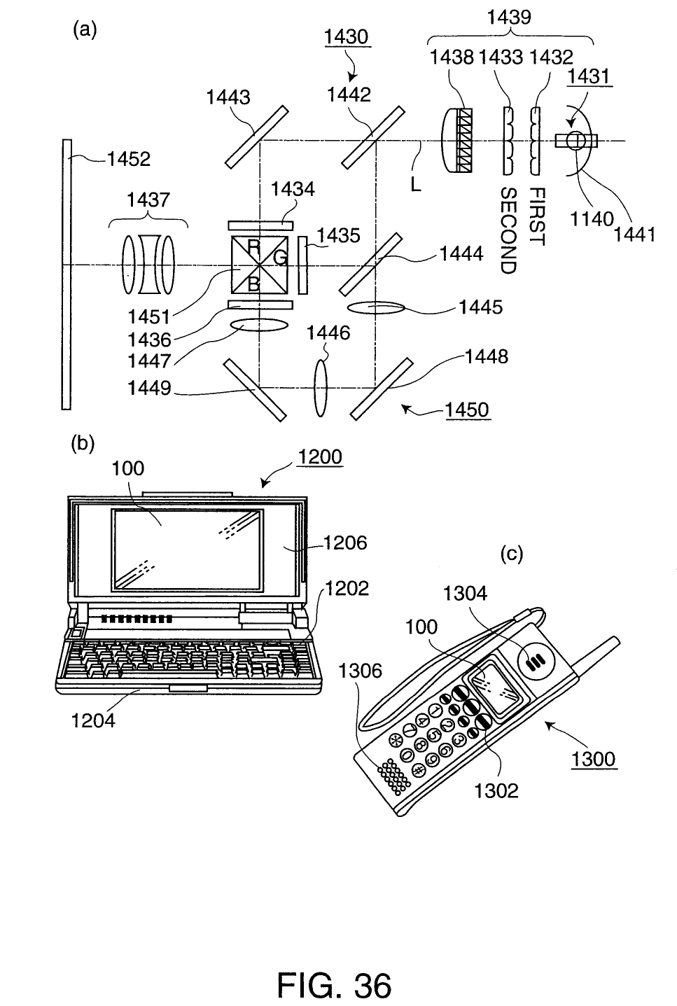

FIG. 34 is a chart showing selection patterns that are to be selected in each frame in the case of the 64-level grayscale 2FRC. For example, when the grayscale data defines the level “6” (000110), then in the first frame, of all the sub-fields included in the first frame, the sub-fields SF1-SF4 are selected which are necessary for forming the selection pattern 4 shown in FIG. 33. In the second frame, of all the sub-fields included in the second frame, the sub-fields SF2-SF4 are selected which are necessary for forming the selection pattern 3 shown in FIG. 33.

Moreover, about the sixth embodiment, in addition to 64 levels of grayscale using 6 bit grayscale data, it is of course possible to provide 256 levels of grayscale using 8 bit grayscale data and the like.

As has been explained, according to the sixth embodiment, by using FRC modulation, it is possible to reduce the number of sub-fields that have a small weight and are to be provided in each frame. Consequently, because the length of the sub-fields having the small weight can be extended, the write time to the pixel can be extended. This makes the data signal readily applied to the liquid crystals with a high accuracy.

Furthermore, as an application example of the first embodiment, by carrying out the above-explained operation with the use of setting shown in FIG. 11, also in the FRC as the sixth embodiment, it is possible to drive the second sub-field by dividing it into a plurality of sub-fields.

### Seventh Embodiment

The following description will describe electronic equipment of an seventh embodiment.

FIG. 35 shows an arrangement of electronic equipment of the seventh embodiment. As shown in FIG. 35, the electronic equipment can include a display information output source 1000 for outputting display information such as an image signal, a display information processing circuit 1002 for successively generating digital signals from the display information, an electro-optic device 1001 discussed in any of the above embodiments, a driving circuit 1004 including the above-discussed scanning line driving circuit 130 and data line driving circuit 140 and for driving the electro-optic device 1001, a clock generating circuit 1008, and a power circuit 1010. Typical examples of the electronic equipment of the eighth embodiment include a projector, a mobile-type computer, and a cellular phone.

FIG. 36(a) shows arrangements of the projector, FIG. 36(b) shows arrangements of mobile-type computer, and FIG. 36(c) shows arrangements of cellular phone. As shown in FIG. 36(a), a projector 1430 includes the above electro-optic device as liquid crystal light modulating devices 100R, 100G, and 100B. As shown in FIG. 36(b), a mobile-type computer 1200 includes the above electro-optic device 100 and a backlight as a display unit 1206. As shown in FIG. 36(c), a cellular phone 1300 includes the above electro-optic device as a display unit 100.

The weight assigned to each sub-field as set in the above examples can be adjusted by taking the characteristics of liquid crystals and the like into consideration. Also, the above examples discussed the liquid crystal display device. It should be appreciated, however, that the present invention can be applied to electro-optic elements, such as an electro luminescent (EL) display, a plasma display, and a digital micro mirror device (DMD) display.

As has been discussed above, according to the pixel driving method of the present invention, the continuity of the sub-fields that should select ON can be secured, and therefore, not only can a shift in a level of grayscale be improved, but also an image quality can be upgraded. Moreover, because a voltage to be applied to the pixels does not transform into a high frequency wave, it is possible to save power consumption.

What is claimed is:

1. A driving method of a liquid crystal element for allowing said liquid crystal element to display a level of grayscale, the liquid crystal element displaying the level of grayscale, throughout a frame period, by switching to an ON-state the liquid crystal element during a period corresponding to grayscale data that defines the level of grayscale, the driving method comprising:
dividing the frame period into a plurality of sub-fields, the plurality of sub-fields having a first group of sub-fields continuous with respect to one another and a second group of sub-fields continuous with respect to one another, the second group of sub-fields being subsequent to the first group of sub-fields,
each of the plurality of sub-fields of the first group of sub-fields having a same first sub-field period and each of the plurality of sub-fields of the second group of sub-fields having a same second sub-field period, the second sub-field period being substantially equal to a sum of a length of the first sub-field periods and a length of any one of the first sub-field periods, a part of sub-field periods of said plurality of first sub-field periods and said plurality of second sub-field periods being included in one frame period of two continuous frame periods, and a rest portion of sub-field periods being included in the other frame period;
selecting, according to the grayscale data, sub-fields that are adjacent to each other in a direction from a temporal position, the temporal position being between the first group of sub-fields and the second group of sub-fields, toward a sub-field of the first group of sub-fields or a sub-field of the second group of sub-fields at a position most remote from the temporal position; and
driving by switching to the ON-state the liquid crystal element during a period that the sub-fields are selected; and
switching to the ON-state a sub-field located between the first group of sub-fields and the second group of sub-fields, regardless of the level of grayscale, to supply a threshold voltage relating to driving the liquid crystal element.

2. The driving method of a liquid crystal element of claim 1, said part of sub-field periods belonging to one of said plurality of first sub-field periods and said plurality of second sub-field periods, and said rest portion of sub-field periods belonging to the other thereof.

3. The driving method of a liquid crystal element of claim 1, in said driving step, a period during which said liquid crystal element is switched ON-state being inserted in said temporal position regardless of said grayscale data.

4. The driving method of a liquid crystal element of claim 1, in said driving step, a period during which said electro-optic element is switched OFF when said grayscale data shows 0 and switched ON-state at other time being inserted in said boundary.

5. The driving method of a liquid crystal element of claim 1, when said second sub-field periods are selected in said selecting step,
in said driving step, of said second sub-field periods selected, at least one second sub-field period being divided into a plurality of divided periods to be switched ON-state.

6. The driving method of a liquid crystal element of claim 5, in said driving step, of said second sub-field periods selected, a second sub-field period positioned near said boundary being divided with priority to be switched ON-state.

7. The driving method of a liquid crystal element of claim 6, when two or more of said second sub-field periods are selected in said selecting step,
in said driving step, of said two or more second sub-field periods selected which are second sub-field periods adjacent to each other, a second sub-field period farther from said boundary is divided to be switched ON-state with the number of division made equal to or less than the number of division of a second sub-field period nearer said boundary.

8. The driving method of a liquid crystal element of claim 5, in said driving step, all of said second sub-field periods selected being divided to be switched ON.

9. The driving method of a liquid crystal element of claim 5, in said driving step, at least one divided period of said plurality of divided periods being equivalent to one first sub-field period.

10. A driving device of a liquid crystal element for allowing said liquid crystal element to display a level of grayscale, the liquid crystal element displays the level of grayscale, throughout a frame period, by switching to an ON-state the liquid crystal element during a period corresponding to grayscale data that defines said level of grayscale, the driving device comprising:
a dividing circuit that divides the frame period into a plurality of sub-fields, the plurality of sub-fields having a first group of sub-fields continuous with respect to one another and a second group of sub-fields continuous with respect to one another, the second group of sub-fields being subsequent to the first group of sub-fields,
each of the plurality of sub-fields of the first group of sub-fields having a same first sub-field period and each of the plurality of sub-fields of the second group of sub-fields having a same second sub-field period, the second sub-field period being substantially equal to a sum of a length of the first sub-field periods and a length of any one of the first sub-field periods, a part of sub-field periods of said plurality of first sub-field periods and said plurality of second sub-field periods being included in one frame period of two continuous frame periods, and a rest portion of sub-field periods being included in the other frame period;
a selecting circuit that selects, according to the grayscale data, sub-fields that are adjacent to each other in a direction from a temporal position, the temporal position being between the first group of sub-fields and the second group of sub-fields, toward a sub-field of the first group of sub-fields or a sub-field of the second group of sub-fields at a position most remote from the temporal position; and
a driving circuit that switches to the ON-state the liquid crystal element during a period that the sub-fields are selected; and
a switching circuit that switches to the ON-state a sub-field located between the first group of sub-fields and the second group of sub-fields, regardless of the level of grayscale, to supply a threshold voltage relating to driving the liquid crystal element.

11. Electronic equipment, comprising:
a display device, including a plurality of liquid crystal elements aligned in a matrix, that displays an image related to said electronic equipment; and
said driving device of a liquid crystal element of claim 10.
